(19) United States
(12) Patent Application Publication
(10) Pub. No.: US 2016/0019370 A1
(43) Pub. Date: Jan. 21, 2016

(54) SYSTEMS AND METHODS FOR COORDINATED PATIENT ENGAGEMENT

(71) Applicant: Habitworks, Inc., Gloucester, MA (US)

(72) Inventors: Paul Cole, Gloucester, MA (US); Demetrie Tyler, Santa Cruz, CA (US)

(73) Assignee: HABITWORKS, INC., Gloucester, MA (US)

(21) Appl. No.: 14/727,866

(22) Filed: Jun. 2, 2015

Related U.S. Application Data
(63) Continuation of application No. 62/006,325, filed on Jun. 2, 2014.

(51) Int. Cl. G06F 19/00

(52) U.S. Cl. CPC G06F 19/3481

(57) ABSTRACT

The present disclosure relates to a system and methods that provide a technology-assisted coaching for changing health-related behaviors and improving adherence.

### BACKGROUND OF THE INVENTION

Patients are often asked to undertake behavioral changes when they have a health issue, diagnosis, disease, or other significant health related event. These behavioral changes may include forming new regular behaviors or habits, such as taking a medication at regular intervals, exercising, monitoring personal health metrics (e.g., weight, blood glucose, blood pressure, etc.) or changing nutritional habits. These types of behavioral changes are critical to the patients' health, and yet they are very challenging to implement. Non-adherence to the new health plan and behaviors can be caused by multiple situational and behavioral factors, including lack of motivation, knowledge, skill, and social support.

While education is an important part of improving patient adherence to new health behaviors, it is just one element. Patients often know what to do, but have difficulty adhering to the new behaviors and making the required change. Coaching has been shown to be an effective means of producing behavior change when implemented properly; however coaching is difficult to scale to large numbers of patients. Technology has the potential to lower the cost of communication with patients. Many current technology-based patient assistance systems focus primarily on the education component of patient behaviors or attempt to provide only reminders, but lack direct support from a care provider or personal coach. There exists a need for coaching systems that provide educational, motivational, emotional, and social support for patients developing new health behaviors by coordinating patient input, caregiver input, and patient performance to automate the customization of a behavior change plan and provide direct coaching to a patient with a care provider.

### SUMMARY OF THE INVENTION

Disclosed herein are systems, devices, and methods for technology-assisted coaching for changing health-related behaviors and improving adherence. The systems and methods include patient coaching system with storage memory and processing circuitry. The processing circuitry is configured to receive patient outcome objective from healthcare provider and store the patient outcome objective in the storage memory, receive patient action plan data and store patient action plan data in the storage memory, and generate and present incremental action plan steps based on patient outcome objective and patient action plan data. The processing circuitry also receives patient selections for incremental action plan steps, receives activity log data at the end of a logging period, receives healthcare provider input data based on activity log data, and generates updated action plan steps.

In certain approaches, a system for providing communication between a patient, healthcare professional, and coach comprising is described herein. The system includes storage memory and processing circuitry. The processing circuitry is configured to receive patient outcome objective from healthcare professional and store the patient outcome objective in the storage memory, generate and present incremental action plan steps based on patient outcome objective, receive obstacle selections for patient, generate an action plan to overcome obstacle selections, receive reminder selections for patient, send reminders based on reminder selections, receive patient performance data, and adjust action plan steps based on patient outcome objectives and patient performance data.

These and other embodiments are described in more detail herein. Variations and modifications of these embodiments will occur to those of skill in the art after reviewing this disclosure. The foregoing features and aspects may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1 depicts a generalized coaching process; and

FIG. 2 illustrates an example of a system that provides personalized coaching and communication to facilitate patient support; and

FIG. 3 is an example of a registration display screen; and

FIG. 4 shows a patient welcome screen; and

FIG. 5 depicts a series of screens for assessing patient behaviors; and

FIG. 6 is an example of a screen for goal selection; and

FIG. 7 illustrates a goal selection screen; and

FIG. 8 shows a confirmation page for a patient action plan; and

FIG. 9 depicts a reminder selection screen; and

FIG. 10 shows example screens for identifying and planning for roadblocks; and

FIG. 11 illustrates a support network identification screen; and

FIG. 12 is a set of display screens for setting up and synchronizing an external health monitoring device; and

FIG. 13 shows screens for daily logging of activities by a patient; and

FIG. 14 is a weekly journal screen; and

FIG. 15 depicts mobile screens for logging activities; and

FIG. 16 shows an action plan and weekly goal summary screen; and

FIG. 17 illustrates message and information screens for supporting a patient's action plan; and

FIG. 18 illustrates a goal page; and

FIG. 19 shows patient summary screens; and

FIG. 20 depicts coaching interface screens; and

FIG. 21 illustrates screens for coach communication; and

FIG. 22 shows screens for broad scale communication from a coach; and

FIG. 23 depicts monitoring and reporting screens for coaches; and

FIGS. 24A-B illustrate a process for developing a patient action plan; and

FIG. 25 shows process steps for supporting a patient action plan; and

FIG. 26 depicts a process for providing plan updates and patient communication.

### DETAILED DESCRIPTION

To provide an overall understanding of the systems, devices, and methods described herein, certain illustrative embodiments will be described. Although the embodiments and features described herein are specifically described for use in connection with technology-assisted health coaching systems, it will be understood that all the components, connection mechanisms, adjustable systems, manufacturing methods, and other features outlined below may be combined with one another in any suitable manner and may be adapted and applied to other areas, including, but not limited to, sports coaching, skill acquisition training, professional mentoring, addiction recovery, and other applications involving coaching and acquiring new behaviors or changing current behaviors.

Disclosed herein are systems, devices, and methods for technology-assisted coaching for changing health-related behaviors and improving adherence. The systems and methods include patient coaching system with storage memory and processing circuitry. The processing circuitry is configured to receive patient outcome objective from healthcare provider and store the patient outcome objective in the storage memory, receive patient action plan data and store patient action plan data in the storage memory, and generate and present incremental action plan steps based on patient outcome objective and patient action plan data. The processing circuitry also receives patient selections for incremental action plan steps, receives activity log data at the end of a logging period, receives healthcare provider input data based on activity log data, and generates updated action plan steps.

The systems and methods described herein have the ability extends the reach of a healthcare team through a technology-assisted coaching platform. Behavior change requires an interactive and personalized goal setting and planning process. Developing new health habits requires continual nudges, reminders and reinforcement. Technology facilitates follow-up and is the only means to cost-effectively provide this level continuous interaction and guidance at scale. For example, the systems and methods described herein may be implemented as an enterprise system with the ability to address multiple health conditions and the underlying behavior change necessary for producing improved health by assisting people in changing behaviors and developing new, positive, healthy habits. In addition to being able to address a much broader set of health conditions effectively, coaches can more readily and easily work with many patients through automated, yet personalized, action plans and communications than is currently available with other approaches. While personalized coaching has been shown to significantly improve people's ability to change behaviors, current coaching approaches are not easily scalable due to factors such as the high cost of hiring additional personnel and the increased time required to communicate with each patient. The systems and methods described herein overcome those limitations and are scalable to large numbers of patients with a broad range of chronic diseases and behavior change needs. The systems and methods described herein make behavior change manageable and measurable. They can be adapted to match the preferences and workflow of a healthcare team, and can be integrated with existing health IT infrastructures.

Adherence to a prescribed behavior plan, such as an exercise plan, diet change, physical therapy, medication plan, is difficult for many patients. Non-adherence results in poor health outcomes and can be costly for both the patient and the healthcare system. Non-adherence can be caused by multiple situational and behavior factors, including lack of motivation, knowledge, skill, and/or social support. Many coaching approaches, including human-based and technology-based coaching systems, emphasize education as the primary, if not exclusive, means of changing patient behavior.

Behavior science emphasizes the active identification of a meaningful goal, specific action steps, feedback, and social support. Research in habit formation indicates that incremental steps, a focus on replacement behaviors, creating triggers and implementation intention planning are effective. For members with chronic conditions, providing incremental opportunities for success, with continuous reinforcement is critical to turning around the self-perpetuating cycles of failure. Addressing the barriers that prevent incremental habit change is key. The systems and methods described herein provide planning and feedback tools, which continually nudge, motivate and support patients' needs to build more healthy habits. They provide adjustable feedback based on the user behaviors, user preferences, healthcare provider inputs, and an overarching action plan.

Patient components of the systems and methods described herein include: assessment, action planning, problem solving, logging, reminders, feedback and messaging. Patient may interact through the web, a mobile application, and email. An interface or dashboard for coaches and healthcare providers enables monitoring, communication, reporting and measurement. The systems and methods described herein are extensible and allow for the integration of wireless health monitoring devices and third party mobile applications to automate tracking. In certain approaches, incentives can be incorporated into a patient's action plan as extrinsic motivators in addition to the intrinsic motivators of improved health and social reinforcement.

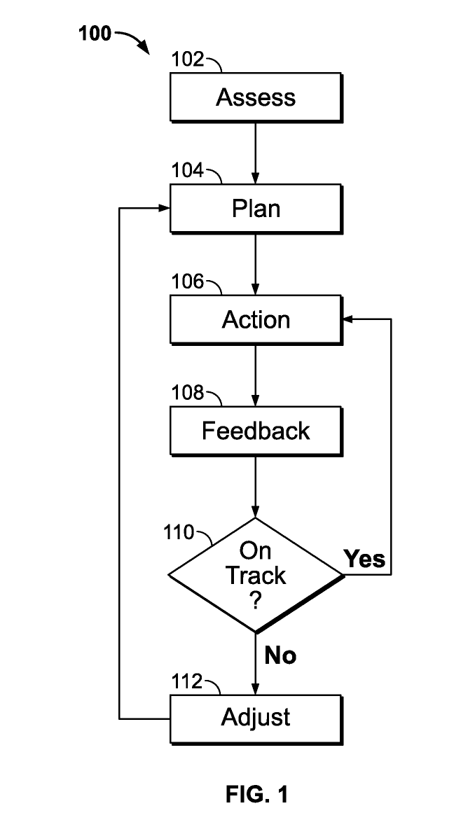

FIG. 1 depicts a general overview of a coaching approach 100 implemented by the systems and methods described herein. At step 102, the processing circuitry (described in further detail below) provide a guided assessment of a patient's health and receive input data from the patient. For example, the processing circuitry may request information about a patient's current behaviors and receive responses from a patient. At step 104, the processing circuitry develops an action plan for the patient. In certain approaches, step 104 is accomplished by requesting patient input on specific actions that the patient would prefer to incorporate into the plan. In certain approaches, the processing circuitry requests information about potential obstacles that the patient may face and suggests ways of overcoming those obstacles. The primary outcome at step 104 from the processing circuitry is a personalized action plan for the patient. At step 104, the processing circuitry may also share the action plan with the healthcare providers for the patients, such as a nurse, coach, or physician. Step 106 focuses on implementing the action plan. The processing circuitry may provide reminders to the patient, and may also provide reminders to the healthcare providers. In certain approaches, the processing circuitry may display an interface, such as a dashboard, for patients, with information regarding the action plan, support information, messages, and inputs for the patient to record actions taken. Additionally or alternatively, the processing circuitry may display an interface, such as a dashboard, for healthcare providers, with information regarding patient actions, support information, and messaging from or to one or more patients.

At step 108, the processing circuitry provides feedback to the patient. In certain approaches, the feedback includes support information, automated messages, messages from the healthcare provider, and/or metrics relative to the action plan and patient goals. The processing circuitry determines at step 110 whether the patient is on track with the developed action plan. If the patient is on track, the processing circuitry proceeds to step 106. If the patient is not on track, the processing circuitry proceeds to step 112 and adjusts the action plan. For example, the processing circuitry may provide recommendations to the patient. The processing circuitry may request and/or receive plan adjustments from the patient. The processing circuitry may request and/or receive plan adjustments from one or more healthcare providers, which are then provided to the patient. The processing circuitry then proceeds to step 104 to finalize and update the action plan for the patient. FIG. 1 illustrates a general overview to provide context. The processes, steps, and approaches utilized by the systems and methods herein are described in further detail below.

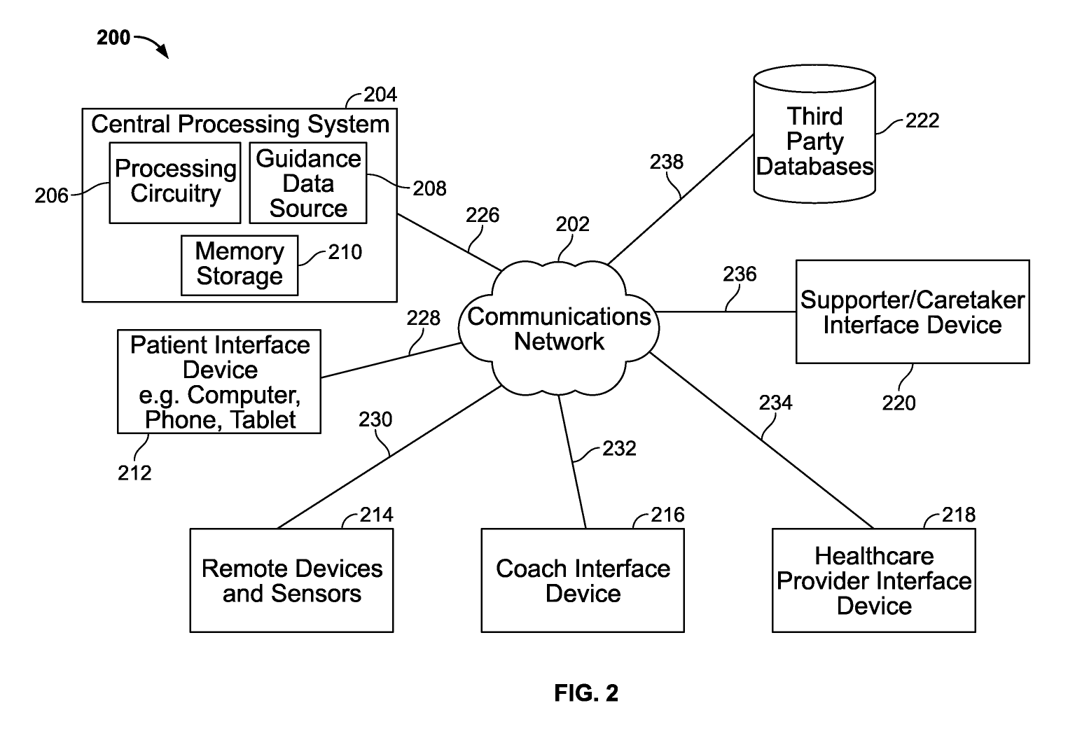

FIG. 2 illustrates an example of a system that provides personalized coaching and communication to facilitate patient support. System 200 provides communication between multiple information sources, such as local storage, network servers, interface devices, remote devices, sensors, and databases. In general, the information is shared, communicated, and generated via communications network 202 by one or more processing circuitry components associated with the various information sources. Communications network 202 may be one or more networks, including, but not limited to cable network, local area network (LAN), wireless network, telephone network, cellular network, satellite network, the internet, or any other suitable communication network. Communication paths 226, 228, 230, 232, 234, 236, and 238 may accordingly be any appropriate communication path, such as cable lines, fiber optic lines, wireless transmission paths, BLUETOOTH, Wi-Fi, satellite transmission paths, telephone lines, or any other suitable wired or wireless communication path, or combination thereof.

Central processing system 204 may be used to send and receive data, commands, user input to or from other network connected systems or devices, such as patient interface devices 212, coach interface devices 216, healthcare provider interface devices 218, supporter interface devices 220, remote devices and sensors 214, and databases 222. Central processing system 204 includes processing circuitry 206, memory storage 210, and data source 208. As described herein, processing circuitry, such as processing circuitry 206, may include any appropriate processing circuitry including, but not limited to, microcontroller, integrated circuit, application specific integrated circuit (ASIC), programmable logic device, field programmable gate array (FPGA), digital signal processors, application specific instruction-set processor (ASIP), or any other suitable digital or analog processors.

Processing circuitry may be coupled to electronic storage or memory. For example, processing circuitry 208 is coupled to memory storage 210. Electronic storage, as used herein, may include any appropriate readable memory media, including, but not limited to, RAM, ROM, EPROM, EEPROM, flash memory or other solid state memory technology, CD-ROM, DVD, or other optical storage, magnetic storage devices, cloud storage, or any other physical or material medium for storing desired information, data, instructions, software, firmware, drivers, or code. For example, storage may contain software instructions for controlling the input, output, and other processes of processing circuitry 206.

Processing system 204 may include guidance data source 208. Data source 208 may include data related health conditions, recommended underlying behavior change, lookup tables, artificial intelligence algorithms, communication messages, and other related guidance data. In certain approaches, data source 208 is integrated with memory storage 210.

System 200 allows for communication between multiple subsystems and users. Users, such as patients, coaches, healthcare providers (e.g., nurses, physicians, therapists), and patient supporters selected by the patient (e.g., family, friends, caretakers, etc. as further described below), may access the coaching and behavior change application and interact with processing circuitry 206 from one or more of user interface device, such as devices 212, 216, 218, and 220. User interface devices may include, but are not limited to, computers, mobile devices, televisions, tablets or any other suitable device. In certain approaches, user interface devices include processing circuitry and storage. For example, storage within a user interface device may hold user data or computer language code. Additionally or alternatively, user interface devices may include a display interface, such as a monitor, television, LED display, LCD display, projection, mobile device, or any other suitable display system. Processing circuitry 206 may provide various screens, such as interface and instruction screens as described in further detail below, at the display of the user interface devices. User interface devices may also include user input devices, such as a keyboard, touchscreen, mouse, microphone, stylus, or any other suitable user input device. These user interface devices (e.g., 212, 216, 218, 220) allow processing circuitry 206 to provide information to the user and to receive user-generated commands, responses, and data. In certain approaches, processing circuitry 206 stores user-generated information in storage 210.

When the systems and methods described herein are used with a patient, the processing circuitry, such as processing circuitry 206 of system 200, conducts a registration process to create a user profile. The initial process includes steps of registration, orientation, assessment, and goal-setting to produce an action plan.

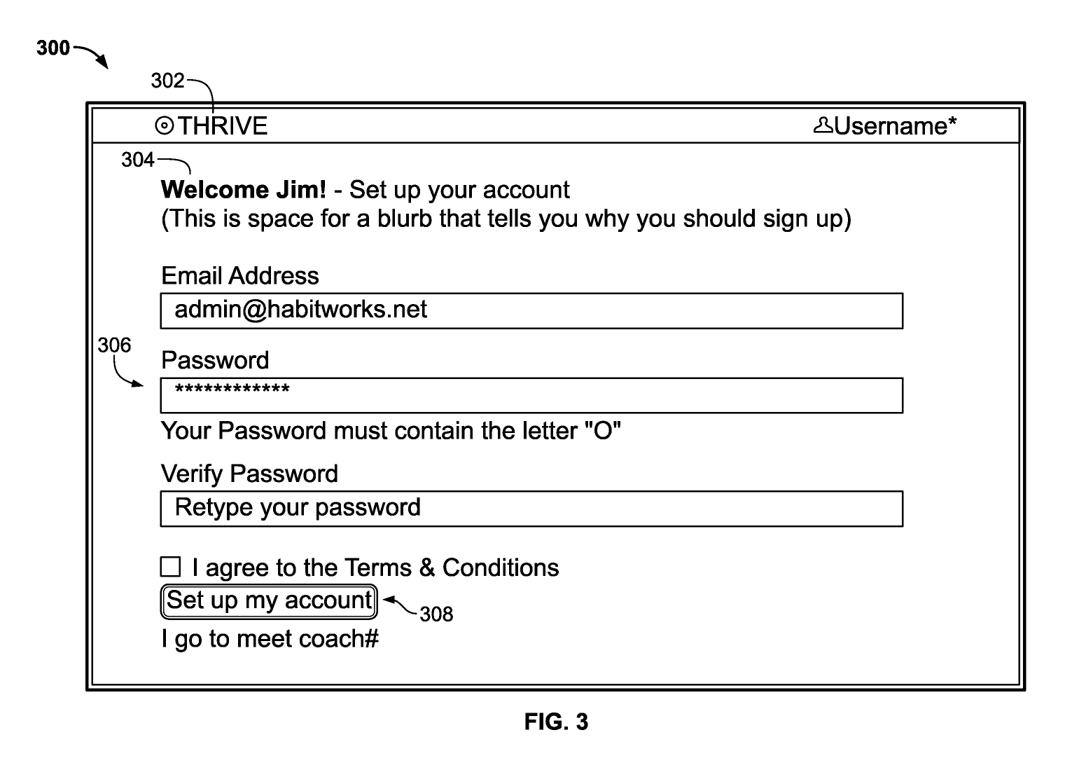

These steps are described in greater details in FIGS. 3-8.

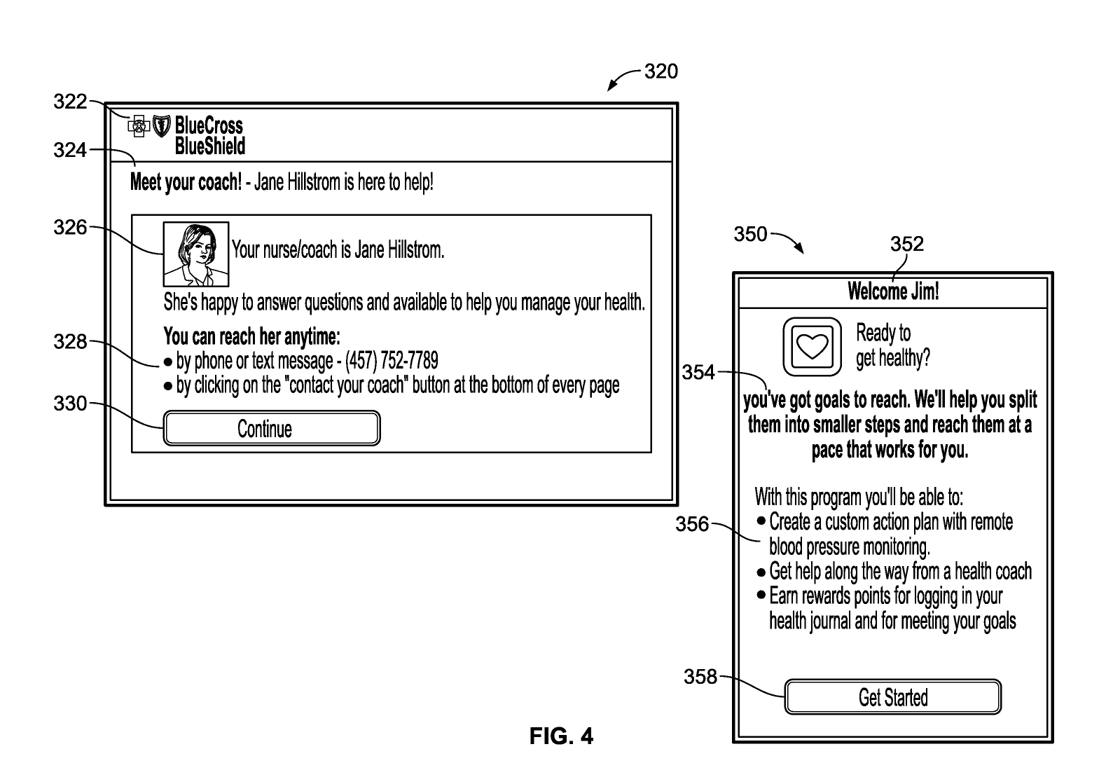

FIG. 3 is an example of a patient registration display screen. The processing circuitry provides and displays screen 300, for example at patient interface device 212. Screen 300, and other screen described herein, may be adjusted to meet the approach, preferences, messaging, and workflows of the healthcare provider or patient. For example, screen 300 may include a branding area 302 for displaying a logo or branded message. Screen 300 may use colors, fonts, or other key messaging to provide an experience consistent with the healthcare provider. In certain embodiments, the processing circuitry provides message area 304 in screen 300. Message area 304 may include a personalized message to the patient and/or instructions. Processing circuitry 304 may provide patient input fields 306. Patient input fields 306 may include input fields such as text input boxes or user selection fields. For example, patient input fields 306 may include input for name, email address, password, patient identification number, healthcare provider, or other pertinent information for registering the patient in the system. Screen 300 includes a submission button 308, which the user can activate after completing input fields 306. Upon activation of button 308, the processing circuitry receives the data from user input fields 306, and may additionally receive other data, such as a timestamp. In certain approaches, the processing circuitry may create a user profile. The processing circuitry may store the user data in memory storage, such as storage 210. In certain approaches, upon activation of button 308, the processing circuitry may display an additional screen, such as screen 320 of FIG. 4.

FIG. 4 shows patient welcome screen 320, which is generated by processing circuitry, such as processing circuitry 206 or processing circuitry within a user device. Screen 320 may include a branding area 322 for displaying a logo or branded message. Screen 320 may use colors, fonts, or other key messaging to provide an experience consistent with the healthcare provider. In certain embodiments, the processing circuitry provides message area 324 in screen 320. Message area 324 may include a personalized message to the patient and/or instructions. For example, the welcome screen may be used to introduce the patient's coach. Screen 320 includes coach introduction area 326, which provides information about the coach, such as a picture and a message. Screen 320 additionally includes messaging area 328, which may provide additional instruction or information, including, but not limited to, contact information for the patient's coach. Additionally or alternatively, the processing circuitry may provide an option for the patient to proceed without a human coach, and therefore no coach introduction is provided in screen 320. As described below, the processing circuitry provides recommendations for modifying or updating the patient action plan. These recommendations can be presented directly to the patient and serve as a digital coach without a human coach. For simplicity, the systems and methods described herein are typically described for the case of including interactions from a human coach. However, involving a human coach is not required. The systems and methods may proceed without a human coach, or, in certain embodiments, may simulate a coach.

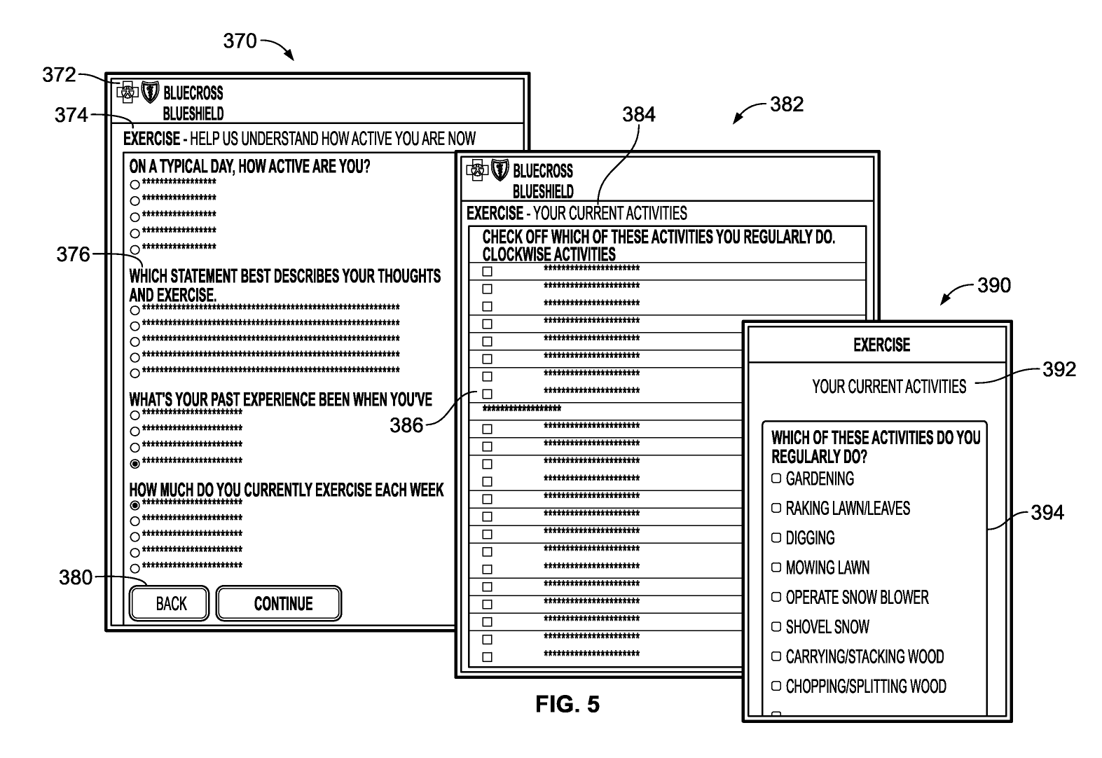

A submission button 330 is also generated on screen 320. For example, submission button 330 may be a “Continue” button. When the submission button is activated, the processing circuitry may generate additional screens, such as those depicted in FIG. 5.

Screen 350 is a mobile version of a welcome screen generated by the processing circuitry. For example, screen 350 may be displayed on a mobile device, such as a phone or tablet. Screen 350 may include a title message 352, first messaging area 354, and second messaging area 356. Messaging area 354 and 356 may provide instructions to the patient. Screen 350 may also include a submission button 358, which, when activated, communicates to the processing circuitry that the user has completed viewing screen 350. Although not depicted, mobile versions of the various screens may also include branding areas, logos, customized colors, or other features to match the approach, preferences, messaging, and workflows of the healthcare provider or patient.

FIG. 5 depicts a series of screens generated by the processing circuitry for assessing patient behaviors. These screens may be displayed at a patient interface device, such as device 212. These assessment screens are customizable. During the initial enterprise setup with a healthcare provider, the processing circuitry can generate exemplar assessment screens. For example, exemplar screens may be included in memory storage 210 or data source 208. Additionally or alternatively, a database of possible questions may be included, from which the processing circuitry receives selections from the healthcare provider.

Screen 370 is an example of a screen generated to understand the activity level of a patient. As can be done with this and all other screens described herein, screen 300 may be customized and may include branding elements, such as branding area 372. Screen 370 depicts a title message 374, which may include an overall title, such as “Exercise,” as well as instructions. Screen 370 includes question area 376. For example, these questions may be directed towards the patient's current exercise habits, frequency, and opinions. Question area 376 includes user input fields, for example, to allow a user to select a response or provide a response, such as through a text input box, checkbox, or radio button. Screen 370 includes submission buttons 380, which the user can activate. Upon activation of the “Back” button, processing circuitry displays a previously viewed screen. In certain approaches, the processing circuitry stores the patient responses to the questions in area 376 in memory so that the patient does not need to answer the questions again at a later time. Upon activation of the “Continue” button, the processing circuitry receives the data from the input fields of 376. The processing circuitry may store the received data in memory storage, such as storage 210. In certain approaches, upon activation of the “Continue” button, the processing circuitry may display an additional screen.

Screen 382 is an additional assessment screen. Screen 382 may include a title message 384, which may include an overall title, such as “Exercise,” as well as instructions. Screen 382 includes question area 386. For example, these questions may be directed towards the patient's current exercise habits, frequency, and opinions. Question area 386 includes user input fields, for example, to allow a user to select a response or provide a response, such as through a text input box, checkbox, or radio button. Screen 382 may also include submission buttons similar to previously described submission buttons.

Screen 390 is a mobile version of an activity assessment screen generated by the processing circuitry. For example, screen 390 may be displayed on a mobile device, such as a phone or tablet. Screen 390 may include a messaging area 392 and question area 394. Messaging area 392 may provide instructions to the patient. Question area 394 includes questions to the patient. For example, these questions may be directed towards the patient's current exercise habits, frequency, and opinions. Question area 394 includes user input fields, for example, to allow a user to select a response or provide a response, such as through a text input box, checkbox, or radio button.

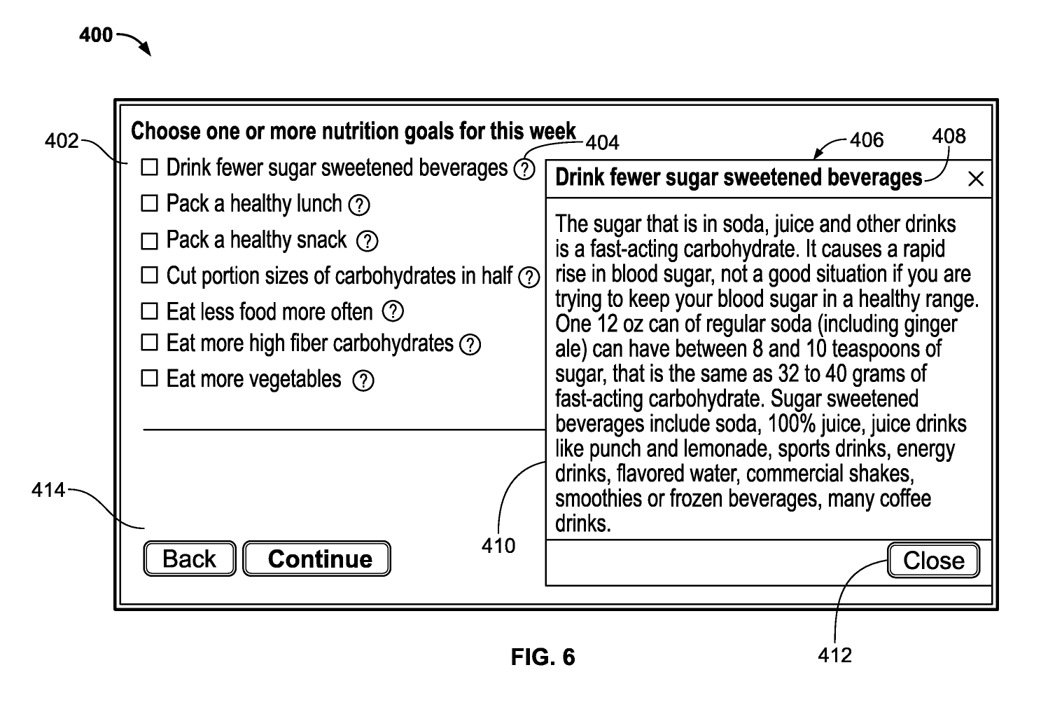

FIG. 6 is an example of a screen for goal selection. The processing circuitry, such as processing circuitry 206 or circuitry in a user interface device, generates screen 400. Screen 400 goal selection area 402. Goal selection area 402 displays goal areas and statements for the user to select and includes user input fields, to allow a user to select a response or provide a response, such as through a text input box or checkbox. In certain approaches, the processing circuitry provides the goal statements from at least one of guidance data source 208, memory storage 210, or third party databases 222. In certain approaches, the goal statements in area 402 include information buttons 404. When the user moves a cursor over buttons 404 or selects buttons 404, the processing circuitry displays more information about that goal statement. For example, the processing circuitry may display information window 406. In certain approaches, window 406 is a pop-out window displayed within or over screen 400. Window 406 may include elements such as a title 408 and text section 410. Text section 410 provides additional details and information related to the goal, such as background information, additional details, recommended specific actions, or definitions. In certain approaches, the processing circuitry provides the information in window 406 from at least one of guidance data source 208, memory storage 210, or third party databases 222. Window 408 may include a “Close” button 412. When button 412 is activated, the processing circuitry receives an indicator and closes window 406.

Screen 400 includes submission buttons 414, which the user can activate and act similarly to previously described submission buttons 380. Upon activation of the “Back” button, processing circuitry displays a previously viewed screen. In certain approaches, the processing circuitry stores the patient responses to the statements in area 402 in memory so that the patient does not need to answer the questions again at a later time. Upon activation of the “Continue” button, the processing circuitry receives the data from the input fields of 402. The processing circuitry may store the received data in memory storage, such as storage 210. In certain approaches, upon activation of the “Continue” button, the processing circuitry may display an additional screen, such as screen 420.

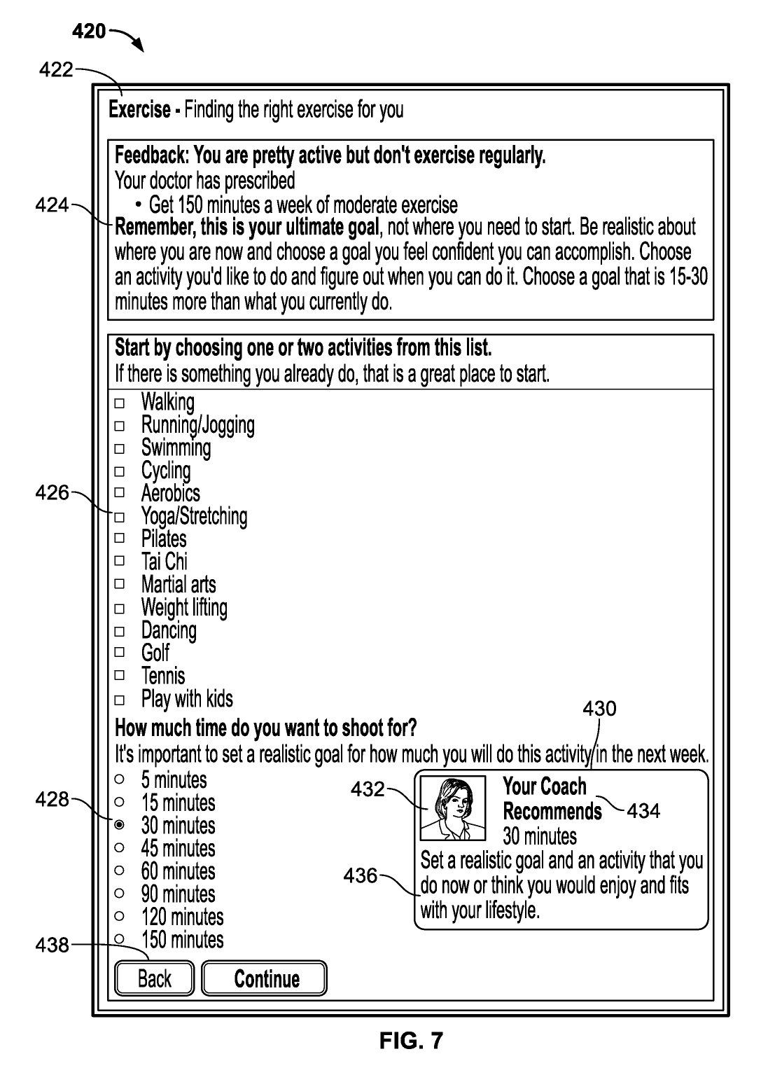

FIG. 7 illustrates an additional goal selection screen 420 generated by the processing circuitry. In certain approaches, screen 420 includes a title message 422, which may include an overall title, such as “Exercise,” as well as instructions or additional messaging. Screen 420 shows feedback section 424. Feedback section 424 may include general feedback statements (e.g., “You are pretty active, but don't exercise regularly”), doctor recommendations (e.g., “You doctor has prescribed 150 minutes a week of moderate exercise), and/or other information or instructions. Screen 420 includes question areas 426 and 428. Question areas 426 and 428 include user input fields, for example, to allow a user to select a response or provide a response, such as through a text input box, checkbox, or radio button. Question area 426 displays specific activities that a patient may include in the action plan. Question area 428 shows times goals for doing an activity selected in question area 426. In certain approaches, screen 420 may include a coach recommendation area 430, which provides input from the coach to help the user make appropriate selections. Coach recommendation area 430 may include a title 434. The title may also include a specific recommendation for a user selection, such as an exercise time of 30 minutes. Area 430 may include a photo 432 and message 436 directed towards the patient. In certain approaches, a recommendation in area 430 is generated automatically by the processing circuitry. Additionally or alternatively, a recommendation may be received from, selected by, or modified by the coach or healthcare provider. Although area 430 depicts a recommendation from a coach, area 430 may additionally or alternatively include input from a nurse, physician, therapist, dietician, or other person supporting the patient. Screen 420 may also include submission buttons, such as a “Back” button or “Continue” button similar to those previously described. After completing the assessment steps, the processing circuitry generates an action plan for the patient.

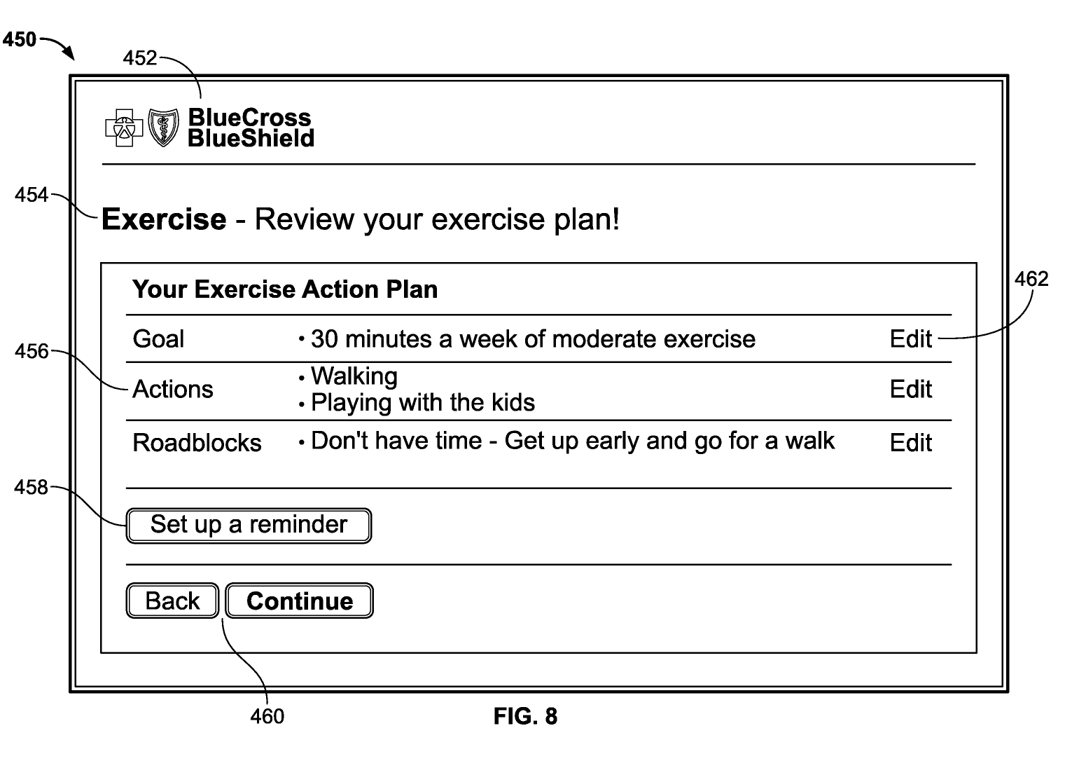

FIG. 8 shows a confirmation page for a patient action plan. Screen 450 is generated by processing circuitry, such as processing circuitry 206 or circuitry in a user interface device. Screen 450 may include a branding area 452 for displaying a logo or branded message and title message 454. Importantly, screen 450 includes an action plan summary 456. The summary 456 displays the patient's goals and specific actions related to the goals. In certain approaches, it includes a “Roadblocks” section, which is developed with the patient and described in further detail below. The “Roadblocks” section may show specific obstacles identified by the patient, which could prevent the patient from achieving the selected goals in the action plan. The “Roadblocks” section may also describe ways of overcoming the obstacle. In certain approaches, screen 450 includes “Edit” buttons 462. When the user selects an “Edit” button 462, the processing circuitry displays screens to allow the user to modify that section of the action plan. Screen 450 also includes a “Set up Reminder” button 458. When buttons 458 is selected, the processing circuitry generates screens and input mechanisms to set up reminders, such as messages or alarms for the user that are delivered to the user at specified times. For example, after receiving an input from button 458, the processing circuitry may generate a screen, such as screen 500 described in further detail below. Screen 450 may also include submission buttons 460, such as a “Back” button or “Continue” button similar to those previously described.

The processing circuitry stores the data related to the developed action plan in memory, such as in memory storage 210 and local memory within patient interface device 212. As will be described in further detail herein, the coach, healthcare providers, and patient-selected supporters, may also be able to access the patient's action plan. For example, the processing circuitry may generate a dashboard for these users. In certain approaches, the processing circuitry notifies these users when the patient the patient has started or completed the registration and action plan development process.

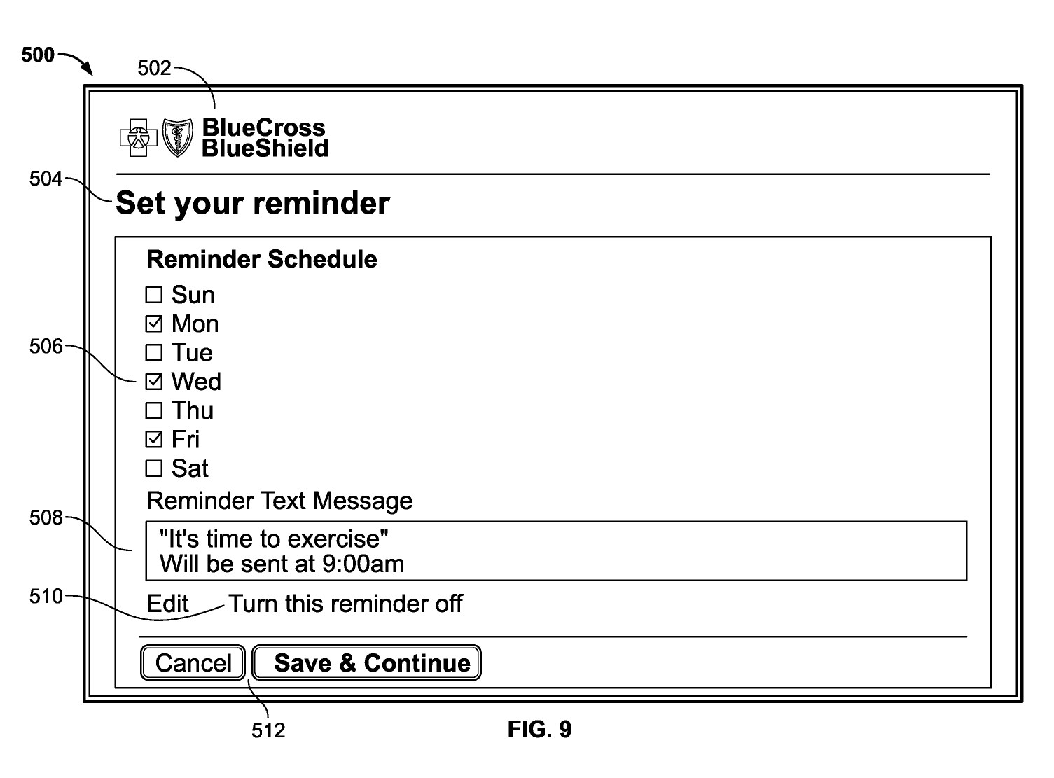

The next general step is in the registration process is to set up supporting tools and content, including, but not limited to, reminders, social support, roadblocks and strategies, and device integration, such as mobile devices and health monitoring devices. This process is described further in relation to FIGS. 9-12.

FIG. 9 depicts a reminder selection screen 500 generated by the processing circuitry. Reminders help the patient to stay on track with the developed action plan. For example, reminders can be helpful in establishing a new habit, such as an exercise habit or medication habit. Screen 502 may include a branding area 502 for displaying a logo or branded message and title message 504. Screen 500 includes a scheduling section 506. Scheduling section 506 displays days, dates, and/or times for receiving a reminder. Message section 508 allows the user to select a message which will be sent as a reminder. For example, section 508 may include a text input box, which the patient can use to provide a message. Section 508 may also include pre-set messages, from which the user can select. In certain approaches, screen 500 includes modification buttons 510 to allow the user to further edit the message or to turn off the reminder. Screen 500 may also include submission buttons 512, such as a “Back” button or “Continue” button similar to those previously described. Upon completion of screen 500, the processing circuitry saves the received data, for example, in storage memory 210 and/or in local memory, such as at patient interface device 212.

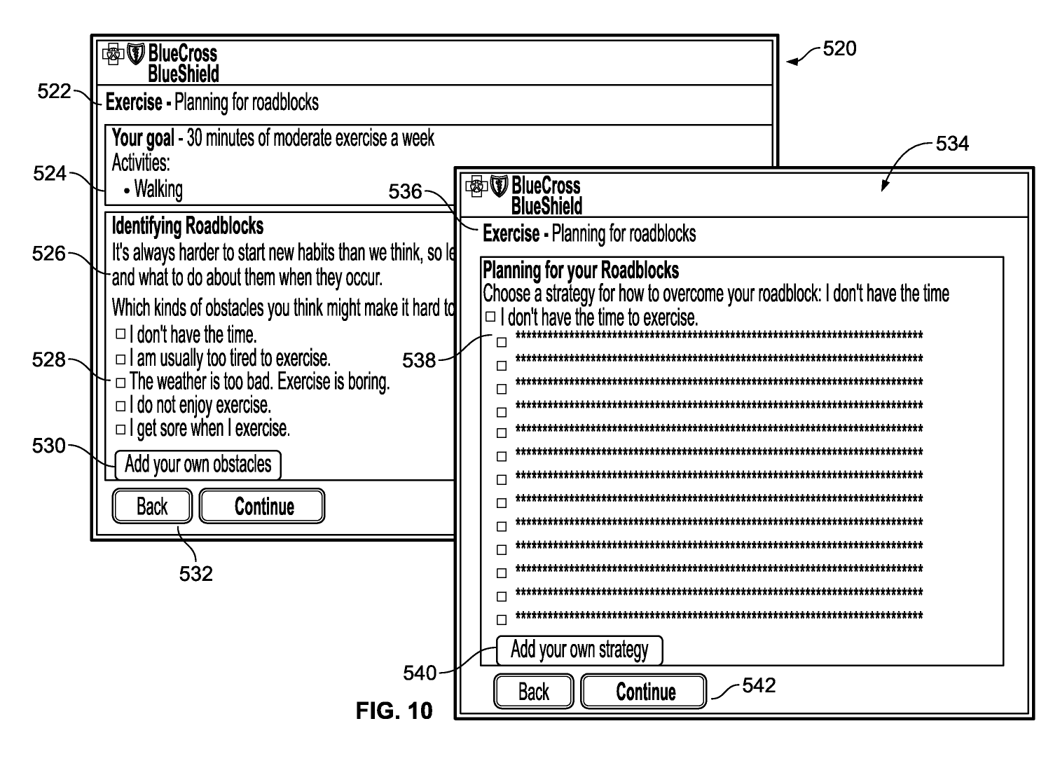

FIG. 10 shows example screens for identifying and planning for roadblocks. Screen 520 is a roadblock identification screen generated by the processing circuitry. Screen 520 guides the patient to identify specific roadblocks, which may prevent the patient from achieving a goal. Screen 520 includes title message 522, which may display a title and other messaging. A goal summary 524 is also included, which shows one or more specific goals and actions from the patient's action plan. Message section 526 provides instructions and support information. For example, message section 526 may include text or figures to explain what roadblocks are and help the patient frame his or her thinking around identifying possible roadblocks. Roadblock identification section 528 shows roadblocks that that may be relevant to the patient. For example, section 528 may display text or images for roadblocks, such as “I don't have the time” or “I am usually too tired to exercise.” Section 528 may include input fields, such as text input boxes, checkboxes, and radio buttons to allow the patient to select specific roadblocks. A patient may also choose to input obstacles not included in section 528 by pressing button 530, which allows the patient to input customized roadblocks, for example, in a text box. Screen 520 may also include submission buttons 532, such as a “Back” button or “Continue” button similar to those previously described. Upon completion of screen 500, the processing circuitry saves the received data, for example, in storage memory 210 and/or in local memory, such as at patient interface device 212.

Screen 534 is a roadblock planning screen generated by the processing circuitry. Screen 534 guides the patient to identify strategies for overcoming roadblocks. Screen 534 includes title message 536, which may display a title and other messaging. Strategy section 538 shows potential strategies that may be useful in overcoming the roadblocks. Section 538 may include a summary of the specific goal and the previously identified roadblock selected from screen 520. In certain approaches, strategy section 538 displays text or images for strategies for overcoming a specific roadblock. For example, a possible strategy for overcoming a lack of time may include getting up early. Section 538 includes input fields, such as text input boxes, checkboxes, and radio buttons to allow the patient to select specific strategies. A patient may also choose to input strategies not included in section 538 by pressing button 540, which allows the patient to input customized strategies, for example, in a text box. Screen 534 may also include submission buttons 542, such as a “Back” button or “Continue” button similar to those previously described. Upon completion of screen 500, the processing circuitry saves the received data, for example, in storage memory 210 and/or in local memory, such as at patient interface device 212.

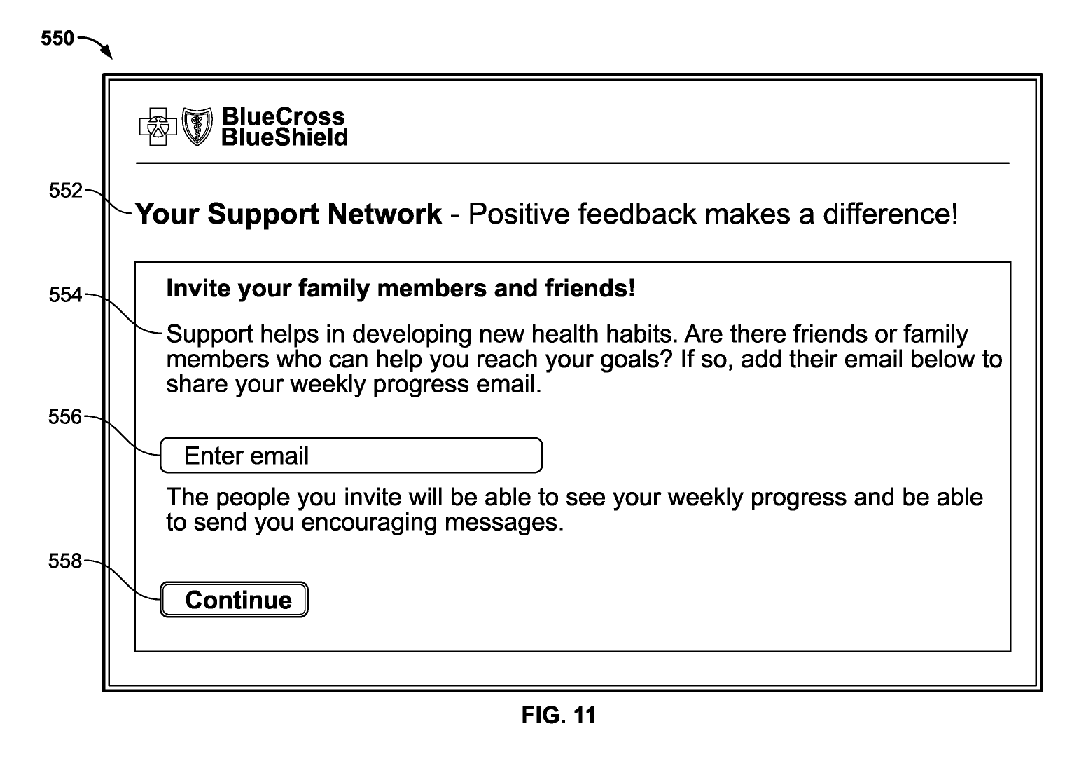

FIG. 11 illustrates a support network identification screen 550. Users or patients can choose to have progress reports sent to one or more friends, family members, caretakers, or other support people with the goal of getting support for making specific behavioral changes. For example, reports may be sent by the processing system by mail, email, text message, or other communication means. In certain approaches, supporters are provided access to an electronic communication dashboard, for example, through a web interface or mobile application, so that they can see the progress of the patient at any time.

Screen 550 is generated by the processing circuitry, such as processing circuitry 206 or processing circuitry within an interface device. Screen 550 includes title message 552, which may display a title and other messaging. Section 554 includes messaging and instructions directing the user to invite, at his or her own will, friends, family, or other support members. In certain approaches, identifying support is mandatory. Section 554 may also include text or images describing how the support network will be contacted, what information the support network will receive, and the benefits or developing a support network during the behavior change process. Screen 550 includes patient input fields 556. Patient input fields 556 may include input fields such as text input boxes, selection boxes, and/or radio buttons to allow the user to input information. For example, patient input fields 556 may include input fields for name, email address, phone number, password, patient identification number, relationship to the patient, or other pertinent information for identifying and contacting members of the patient's support network. Screen 550 includes a submission or “Continue” button 308, which the user can activate after completing input fields 556. Upon activation of button 558, the processing circuitry receives the data from user input fields 556. The processing circuitry may store the user data in memory storage, such as storage 210. In certain approaches, upon activation of button 308, the processing circuitry may display additional screens.

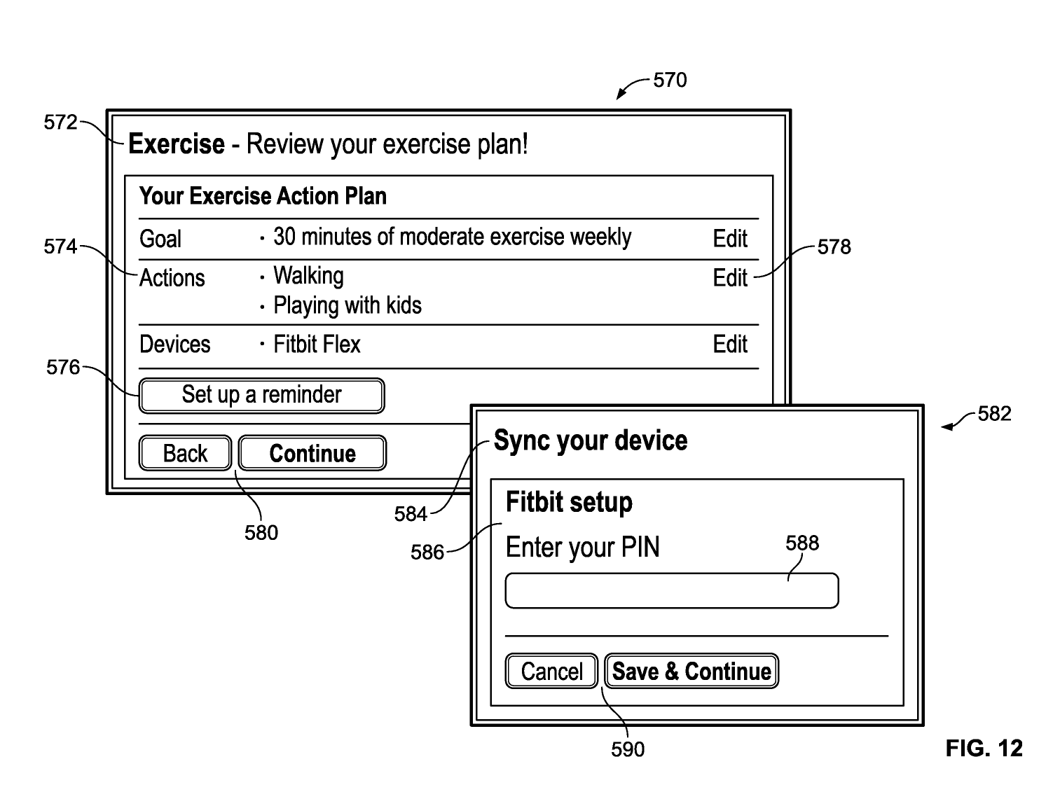

FIG. 12 is a set of display screens for setting up and synchronizing an external health monitoring device. Screens 570 and 582 are generated by the processing circuitry. Screen 570 shows a summary of a patient's action plan, and includes a title message 472 and action plan summary 574. Summary 574 displays the patient's goals and specific actions related to the goals. In certain approaches, it may display roadblocks and strategies for overcoming the roadblocks. Screen 570 also displays information about external health monitoring devices in summary 574. Screen 570 may also include a reminder setup button 576, which when activated, notifies the processing circuitry to generate a reminder set up process, such as those depicted in FIG. 9.

In certain approaches, screen 570 includes “Edit” buttons 578. When the user selects an “Edit” button 578, the processing circuitry displays screens to allow the user to modify that section of the action plan. For example, is a user selects to edit the “Devices” section, the processing circuitry generates screen 582 for synchronizing an external device, such as a FITBIT, FUELBAND, JAWBONE, heart monitor, or other device for sensing or monitoring physiological parameters of a patient. Screen 582 includes a title or message area 584. Screen 582 may include instruction area 586 for instructing the patient in how to synchronize a device. Screen 582 includes user input fields 588 for selecting and identifying a device. For example, fields 588 may include text input boxes, selection boxes, dropdown selections, and/or radio buttons to allow the user or patient to input information about the device. Input fields 588 may include input fields for name, type of device, PIN number, serial number, or other pertinent information for identifying and communicating with an external device. The processing device may communicate with the external device by sending and/or receiving data related to the patient's health behaviors.

Screens 570 and 582 may also include submission buttons 580 and 590, such as a “Back” button or “Continue” button similar to those previously described. Upon completion of the device setup screens, the processing circuitry saves the received data, for example, in storage memory 210 and/or in local memory, such as at patient interface device 212.

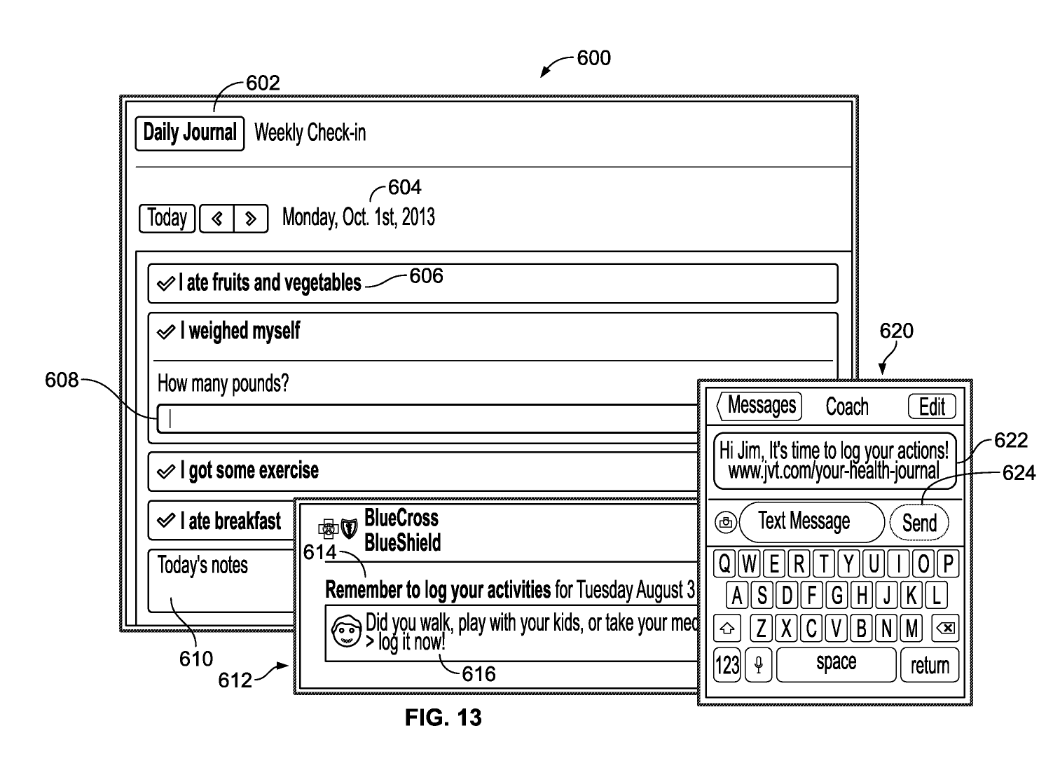

After registration and initial configuration, the systems and methods described herein include feedback and monitoring processes to assist the patient in achieving his or her goals. These process steps may include, but are not limited to daily logging, weekly check-in, feedback and visualization, messaging, and email reports. The steps and processes are further described in relation to display screens depicted in FIGS. 13-20.

FIG. 13 shows screens generated by the processing circuitry for daily logging of activities by the patient. The daily journaling helps develop a cadence for the patient to learn and establish new routines, behaviors, and habits. It enables effective communication between the patient and the coach, healthcare providers, and support network. Journal screen 600 includes header section 602. Header section 602 may include buttons, such as a “Daily Journal” button and “Weekly Check-in” button. When these buttons are pressed, the processing circuitry displays the appropriate screen, e.g., screen 600 for the daily journal and screen 630 for the weekly journal. Screen 600 has a date navigation bar 604. Bar 604 displays the entry date, and may also include buttons for navigating to other dates, such as a “Today” button, a forward arrow or next day button, a back arrow or previous day button, and/or a calendar button.

Screen 600 includes activities area 606. Area 606 displays particular statements, actions, and goals related to the patient's action plan. When the patient clicks a section of area 606, the processing circuitry displays a user input field 608. In certain approaches, the processing circuitry provides additional information or a question related to the selected section. For example, in a section about the patient's weight (e.g., “I weighed myself”), the processing circuitry may display an additional statement near the input fields requesting to know how much the patient weighed (e.g., “How many pounds”). In certain approaches, the user input fields are displayed continually on screen 600. Input fields may include text input boxes, selection boxes, dropdown selections, and/or radio buttons to allow the patient to input data. In certain approaches, screen 600 includes notes input field 610, where the user can record notes about a particular activity or day. For example, the patient may record how he/she feels, struggles, doctor's visits, recent changes, additional details around the goals, or other related factors. In certain approaches, screen 600 includes a request for these notes.

Screen 612 is a reminder notification. In certain approaches, the reminder notification includes a title message 614, such as “Remember to log your activities.” Additionally or alternatively, screen 616 includes a message area 616. Message area 616 may include recommendations, clarifications, and/or links to the journal log. When the user clicks on the link, the processing circuitry can display the appropriate logging screen, such as screen 600. Additionally or alternatively, reminder notifications can be provided through mobile devices, such as cell phones, as depicted by screen 620. Screen 620 includes a reminder message. In certain approaches, the reminder message also includes a link for the appropriate logging screen. Screen 620 additionally includes an input field 624, in which the user can provide information regarding his/her activity.

Screens 602, 612, and 620 are depicted for daily journal logging, but any appropriate journal log may be generated by the processing circuitry. For example, as a patient progresses and begins to successfully implement new behaviors and habits, a weekly log may be more appropriate. Similarly, some activities may not be daily activities, such as particular types of medication or exercise regimens, and therefore would not require a daily log. Upon completion of screens 602, 612, and 620, the processing circuitry saves the data, for example, in memory storage 210 or local storage, such as at an interface device.

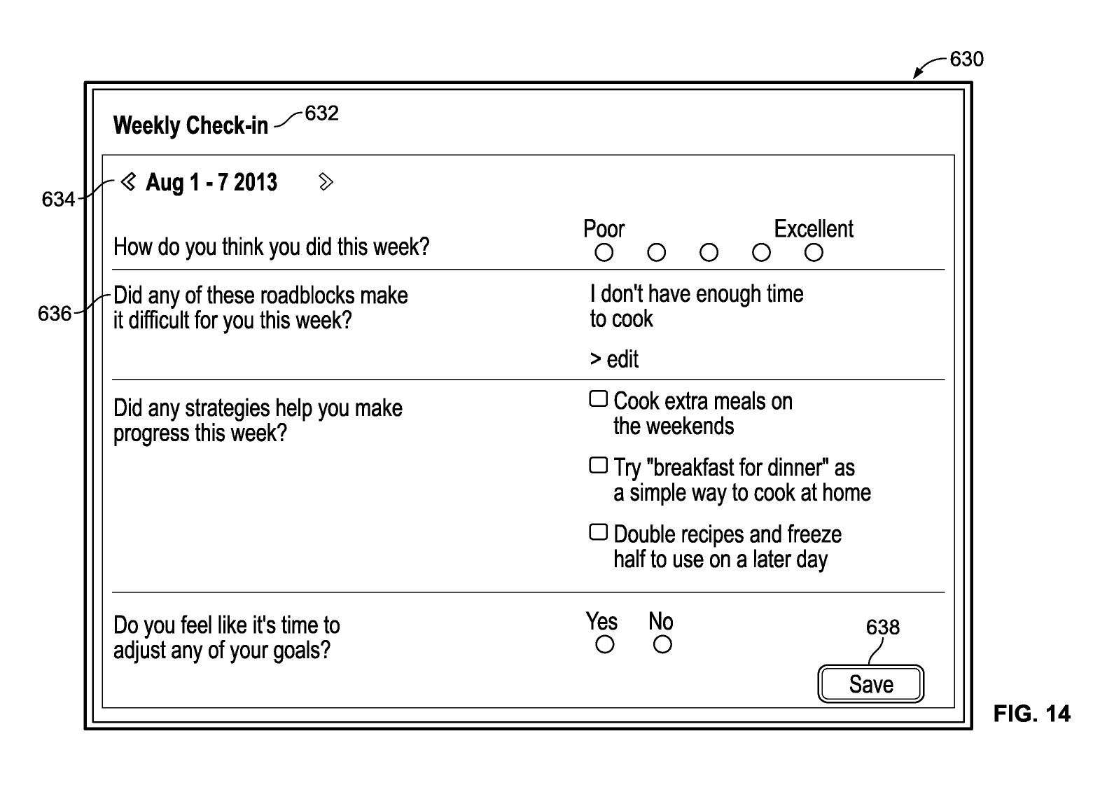

FIG. 14 shows a weekly journal screen 630 generated by the processing circuitry, such as circuitry 206 or processing circuitry in an interface device. In general, the weekly journal focuses more on the whole week, such as how the week went, roadblocks encountered, strategies used, and changes to update the patient's action plan. The weekly journaling helps develop a cadence for the patient to learn and establish new routines, behaviors, and habits. It also enables effective communication between the patient and the coach, healthcare providers, and support network.

Screen 630 includes a header or title message 632. Screen 630 has a date navigation bar 632. Bar 604 displays the entry week, and may also include buttons for navigating to other dates, such as a forward arrow or next week button, a back arrow or previous week button, and/or a calendar button. Question section 636 includes questions about the patient's week, as well as input fields for collecting the patient's responses. Input fields may include text input boxes, selection boxes, dropdown selections, and/or radio buttons. In certain approaches, section 636 asks the patient to rate how the week went, identify specific roadblocks he/she encountered, select strategies that the patient tried, identify strategies that worked or did not work, and/or state whether the patient would like to make changes to the action plan. Screen 638 includes a “Save” button. When activated, the processing circuitry saves the patient input data from screen 630. For example, the processing circuitry may save the data in memory storage 210 or in local memory in an interface device.

The processing circuitry can communicate appropriate portions of data logged by the patient to coaches, healthcare providers, and the patient's support network. For example, these other users may have access to an electronic dashboard for viewing patient progress. Additionally or alternatively, the processing circuitry may incorporate these data in algorithms and workflow logic steps to change the action plan, provide recommendations to the patient, and provide recommendations to the coach, healthcare provider, or support network.

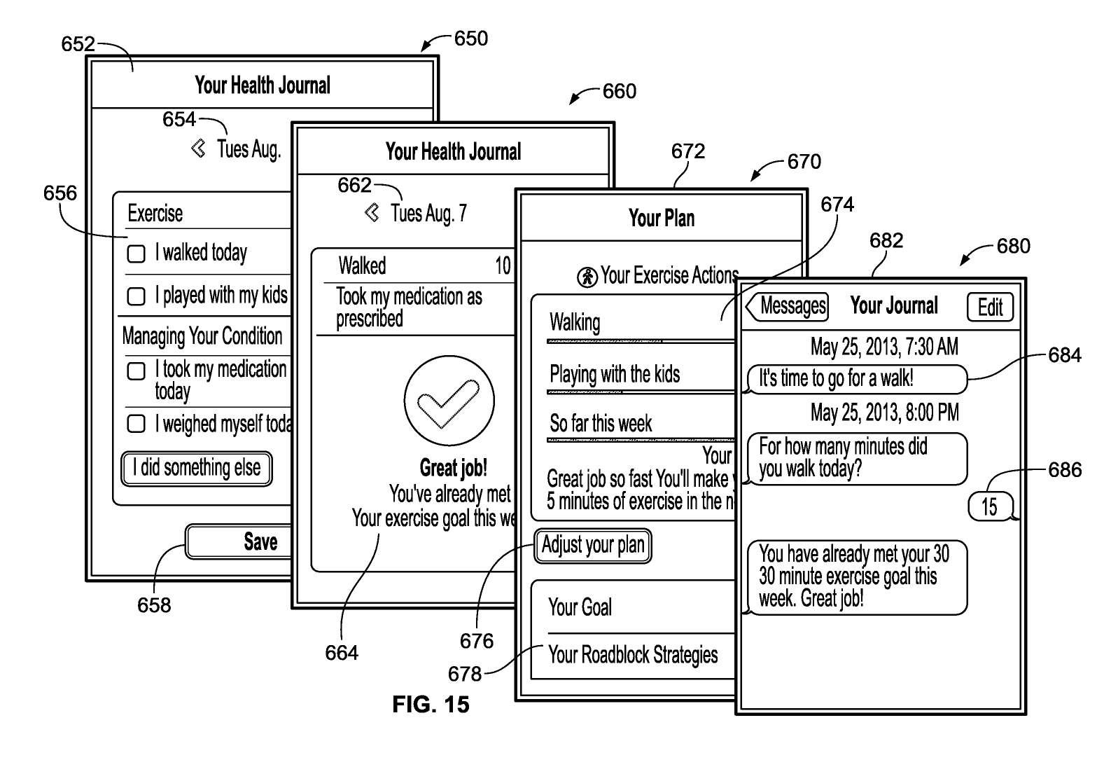

FIG. 15 depicts mobile screens for logging activities. These mobile screens are generated by the processing circuitry, such as processing circuitry 206 or the processing circuitry of an interface device, such as a phone or tablet.

Screen 650 is similar to screen journal 600 described previously. Screen 650 includes a title message, such as “Your Health Journal,” to indicate to the patient the purpose of screen 650. Screen 660 has date navigation bar 656. Bar 656 displays the entry date, and may also include buttons for navigating to other dates, such as a “Today” button, a forward arrow or next day button, a back arrow or previous day button, and/or a calendar button. Screen 650 includes activities area 656. Area 656 displays particular statements, actions, and goals related to the patient's action plan. Area 656 includes user input fields, such as text input boxes, selection boxes, dropdown selections, and/or radio buttons, for inputting the responses. In certain approaches, the processing circuitry provides additional information or question related to a selected section. For example, in a section about the patient's weight (e.g., “I weighed myself”), the processing circuitry may display an additional statement near the input fields requesting to know how much the patient weighed (e.g., “How many pounds”). In certain approaches, the processing circuitry provides an input field to input data not listed. For example, screen 650 may include a button that says, “I did something else.” If the user presses that button, the processing circuitry provides an additional input field. In certain approaches, screen 650 includes a notes input field, where the user can record notes about a particular activity or day. In certain approaches, screen 650 includes a “Save” button. When pressed, the processing circuitry saves the data recorded on screen 650.

Screen 660 is an example of an activity summary page. In certain approaches, screen 660 is displayed by the processing circuitry after screen 650. Screen 662 includes a date navigation bar 662. Bar 662 displays the entry date, and may also include buttons for navigating to other dates, such as a “Today” button, a forward arrow or next day button, a back arrow or previous day button, and/or a calendar button. Screen 662 has a message area 664. Message area 664 displays text, images, video, animations, illustrations, infographics, audio, and/or other media to support the patient. For example, area 664 may include recommendations, messages from a coach, and/or a support message (e.g., Great Job!).

Screen 670 is a mobile version of an action plan summary. Screen 670 includes a title message 672. Screen 674 also includes a progress summary area 674 to indicate the patient's progress in the current time period. Area 674 may include text, images, video, animations, illustrations, infographics, audio, and/or other media to summarize the patient's progress. For example, area 674 may include a bar graph to show how far along a patient is in meeting a goal (e.g., 30 minutes of exercise out of a goal of 90 minutes). Screen 670 includes button 676, which allows a user to adjust his/her action plan. When the user presses button 676, the processing circuitry provides user input fields for entering updated goals and actions. Screen 670 includes goal summary area 678. Area 678 provides a summary of the patient's overall goals, and may also summarize other aspects of the patient's action plan, such as roadblock strategies.

Screen 680 is a text message based journal screen. It has a title message 682. It includes messages 684 to the patient and messages 686 from the patient. For example, messages 684 may include reminders to the patient, support messages (e.g., “Good Job!”) or request for information about the patient's activities, such as “For how many minutes did you walk today?” The patient may respond using patient input messages 686. In certain approaches, the patient may ask questions or record other information using messages 686.

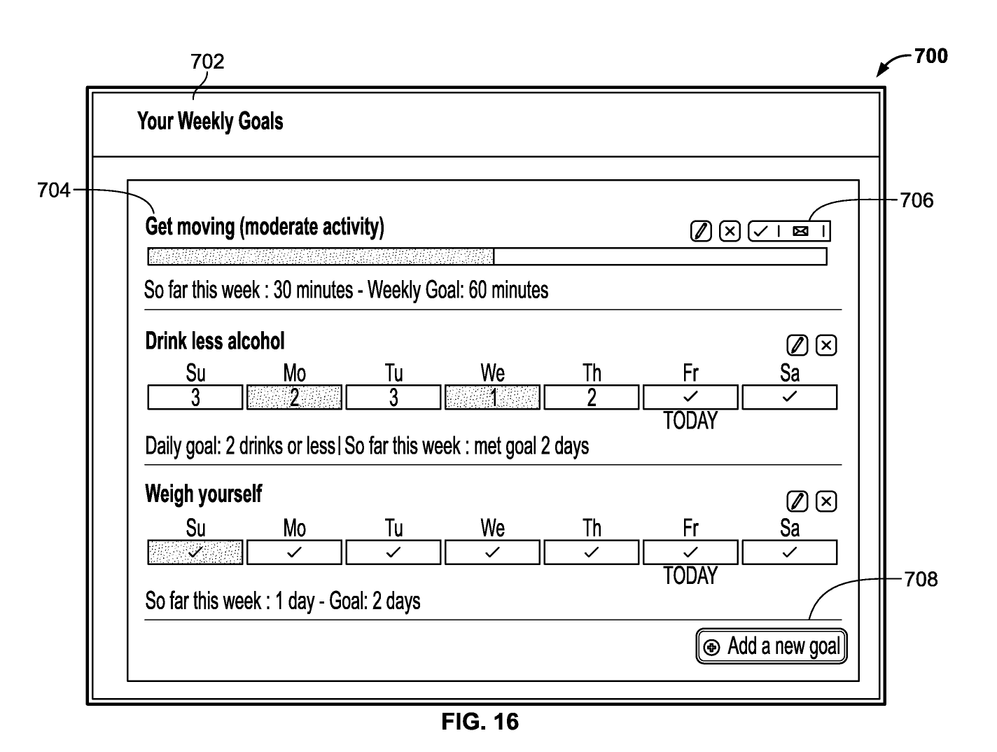

FIG. 16 shows an action plan and weekly goal summary screen. Screen 700 is generated by processing circuitry, such as processing circuitry 206 or processing circuitry in a user interface device). Screen 700 includes a title message 702. Screen 700 also includes a progress summary area 704 to indicate the patient's progress in the current time period. Area 704 may include summaries for one or more of the patient's goals. In certain approaches, screen 700 displays the results of a daily log in area 704. Area 704 may include text, images, video, animations, illustrations, infographics, audio, and/or other media to summarize the patient's progress. For example, area 704 may include a bar graph to show how far along a patient is in meeting a goal (e.g., 30 minutes of exercise out of a goal of 90 minutes). In certain embodiments, screen 700 and other screens may include gaming functionality, such as scores, points, and awards. These scores, points, and awards may be related directly to patient performance, or in certain approaches, may include comparisons to other people, such as other users or a database or stored user data. In certain approaches, the goals in areas 704 are active links, which are linked by the processing device to a goal page, such as screen 750 described below. Screen 700 includes buttons 706, which allow a user to adjust his/her action plan. Screen 708 may include a button 708 for adding additional goals. When the user presses button 708, the processing circuitry provides user input fields to allow the user to input a new goal.

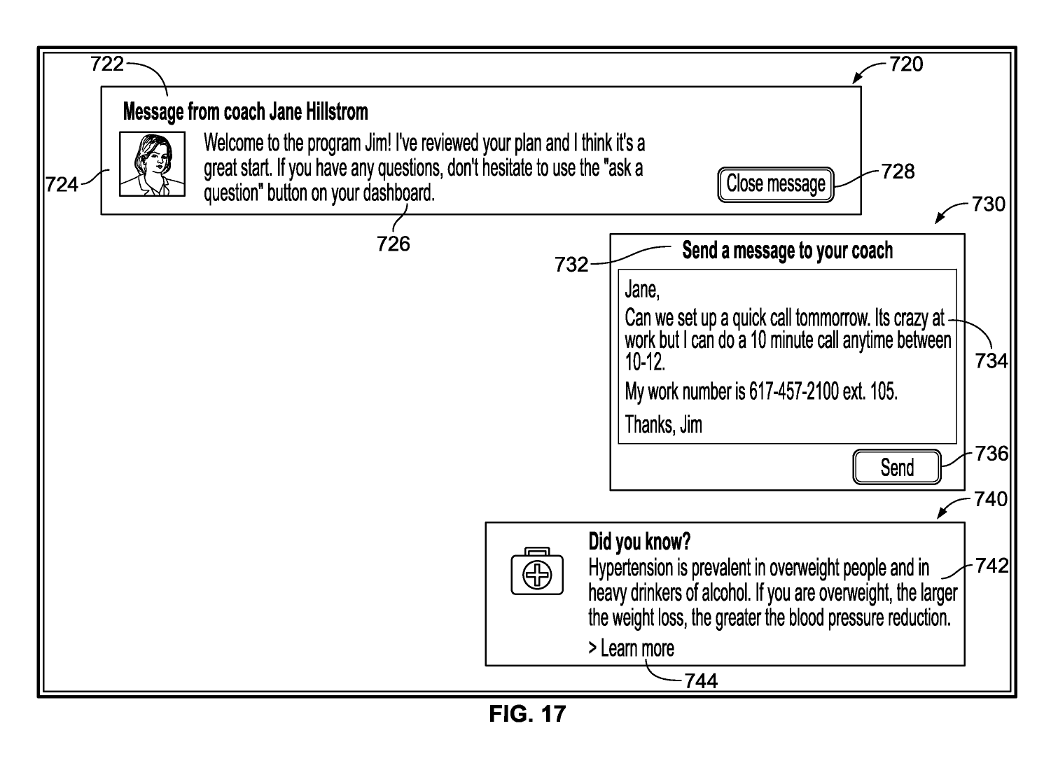

FIG. 17 illustrates message and information screens for supporting a patient's action plan. The screens depicted in FIG. 17 are generated by the processing circuitry and may be provided independently or in conjunction with other screens described herein, such as with screen 700. For example, these screens may be implemented as pop-up windows or may be shown by the processing circuitry in response to user input, such as pressing a button.

Screen 720 is a coach message screen. Screen 720 includes a message title 722 and message text 726. In certain approaches, message text 726 includes text, images, video, animations, illustrations, infographics, audio, and/or other media as part of the message to the patient. In certain approaches, a coach photo 724 is included in screen 720. Screen 720 may include a “Close” button 728. When the patient presses “Close” button 728, the processing circuitry closes screen 720.

Screen 730 is an example of a patient message screen, through which the patient can provide a message to the coach or healthcare provider. Screen 730 includes a title message 732, such as “Send a message to your coach.” Input field 734 allows a user to provide a message for the coach. When the user presses “Send” button 736, the processing circuitry receives the data from screen 730. The processing circuitry may then save the data and display it to the coach or healthcare provider, such as in a dashboard or other message window.

Screen 740 is an information window. Screen 740 includes a message area 742 with support information for the patient. Support information may, for example, include information about a particular condition, nutrition, or exercise. Area 742 may include text, images, video, animations, illustrations, infographics, audio, and/or other media for the patient. In certain approaches, a link 744 is provided to allow the user to learn more about the topic addressed in area 742. When the user presses link 744, the processing circuitry may display additional information.

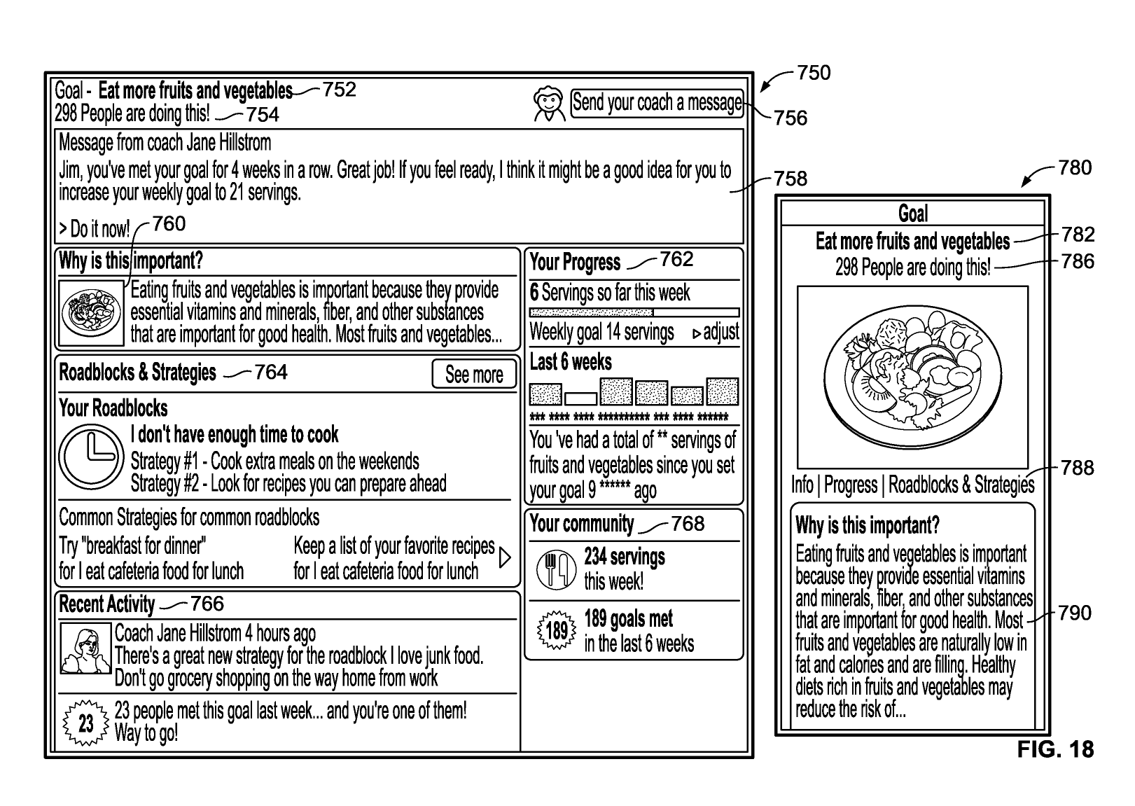

FIG. 18 illustrates a goal page 750 generated by the processing circuitry. Page 750 may include content from various sources, including the user, health databases, coaches, healthcare providers, and other users. The content may be provided as text, images, video, animations, illustrations, infographics, audio, and/or other media. Page 750 includes various content areas, not all of which may be provided in every patient's dashboard. Instead, the areas described are examples. The content areas and types of content provided can be adjusted to for individual patients or healthcare providers.

Goal page 750 includes a title message 752, which describes the specific goal that the patient has set. In certain approaches, page 750 includes a community indicator 754 to indicate how many other people are also working on a similar goal. A button 756 is included for messaging the patient's coach. When the user presses button 756, the processing circuitry provides a message input box, such as screen 730. Page 750 additionally includes a coach message 758 for displaying messages from the patient's coach.

Page 750 may include a variety of content areas. In certain approaches, page 750 includes education area 760. Area 760 may include information about a particular condition, nutrition, or exercise. Area 760 may include text, images, video, animations, illustrations, infographics, audio, and/or other media for the patient. In certain approaches, a link is provided to allow the user to learn more about the topic addressed in area 760. Roadblock summary area 740 includes a summary of roadblocks the patient has identified related to the particular goal on page 760.

Roadblock summary area 740 may also include selected strategies for overcoming the roadblocks. Progress summary area 762 indicates the patient's progress in the goal area of page 750. Area 762 may include text, images, video, animations, illustrations, infographics, audio, and/or other media to summarize the patient's progress. For example, area 762 may include a bar graph to show how far along a patient is in meeting a goal (e.g., 30 minutes of exercise out of a goal of 90 minutes). Community summary area 768 may also be included in page 750. The community summary area includes information about how the community is performing relative to the goal. For example, it may include text, images, video, animations, illustrations, infographics, audio, and/or other media to indicate metrics such as how many people are participating in the goal, how much they have done (e.g., how many servings, how much exercise time, etc.), and how many goals have been met. In certain approaches, page 750 includes an activity feed 766. Activity feed 766 may include, for example, information from a coach, educational information obtained by the processing circuitry from memory or external databases, community activity, and recent progress updates.

Screen 780 is a mobile version of a goal page. Screen 780 includes a title message 782, which describes the specific goal that the patient has set. In certain approaches, screen 780 includes a community indicator 786 to indicate how many other people are also working on a similar goal. Screen 788 may include navigation buttons 788, which allow the user to select specific types of information and updates to view, such as educational information, progress, community updates, recent activity, roadblocks and strategies. Screen 780 may also include a display box 790 for displaying the selected information. Box 790 may include text, images, video, animations, illustrations, infographics, audio, and/or other media.

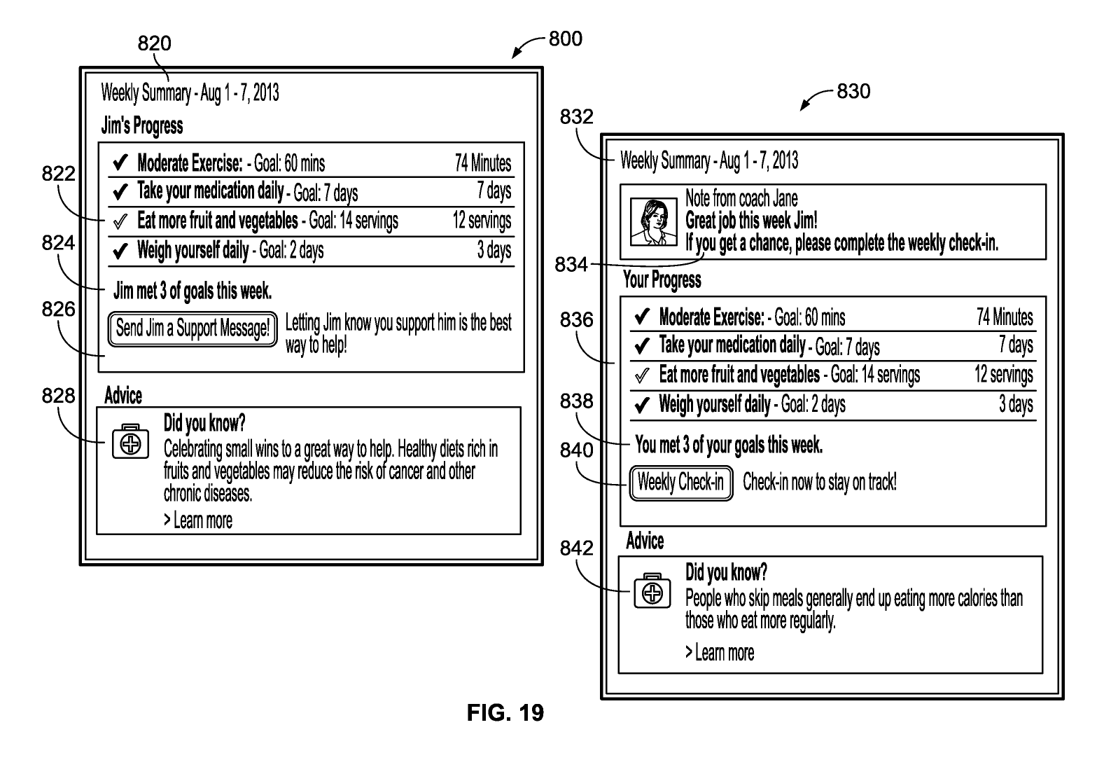

FIG. 19 shows patient summary screens generated by the processing circuitry. Screen 800 is an example of a patient summary screen generated for the coach. Screen 830 is an example of a patient summary screen generated for the patient.

Screen 800 includes title message 820, such as “Weekly Summary.” Title message 820 may display the summary period, such as dates, and may include buttons for navigating to other summary periods. Patient summary area 822 shows the patient's goals, the patient's performance, and whether the patient has met those goals. Area 822 may include text, images, video, animations, illustrations, infographics, audio, and/or other media. For example, area 822 may include a statement of each goal, the summary of the patient's performance (time exercised, servings, weight, etc.), and an indicator, such as a checkmark, to show whether the goal was achieved. A summary statement 824 may also be provided to indicate how many of the patient's goals were met. In certain approaches, screen 800 includes a message button 826 to allow the coach to input a message for the patient. In certain approaches, the processing circuitry provides advice to the coach in advice area 828. The advice to the coach can provide suggestions on best practices and ways to interact with and support the patient.

Screen 830 is an example of a patient summary screen generated for the patient. In certain approaches, the processing circuitry generates a summary, such as the one depicted on screen 830, over regular intervals, such as weekly. In certain approaches, the processing circuitry sends the summary to the patient, coach, and/or patient support network by email or other electronic communication method. Screen 830 includes title message 832, such as “Weekly Summary.” Title message 832 may display the summary period, such as dates, and may include buttons for navigating to other summary periods. In certain approaches, screen 820 includes a coach message 834 for displaying messages from the patient's coach. Patient summary area 836 shows the patient's goals, the patient's performance, and whether the patient has met those goals. Area 836 may include text, images, video, animations, illustrations, infographics, audio, and/or other media. For example, area 836 may include a statement of each goal, the summary of the patient's performance (time exercised, servings, weight, etc.), and an indicator, such as a checkmark, to show whether the goal was achieved. A summary statement 838 may also be provided to indicate how many of the patient's goals were met. In certain approaches, screen 800 includes a “Check-in” button 840 to allow the patient to provide updated progress. For example, when button 840 is pressed, the processing device may display a journal screen, such as screen 600 or 630, or an action plan screen, such as screen 700. In certain approaches, the processing circuitry provides advice to the patient in advice area 842. The processing circuitry may analyze the patient's progress and goals to provide personalized, relevant advice to the patient.

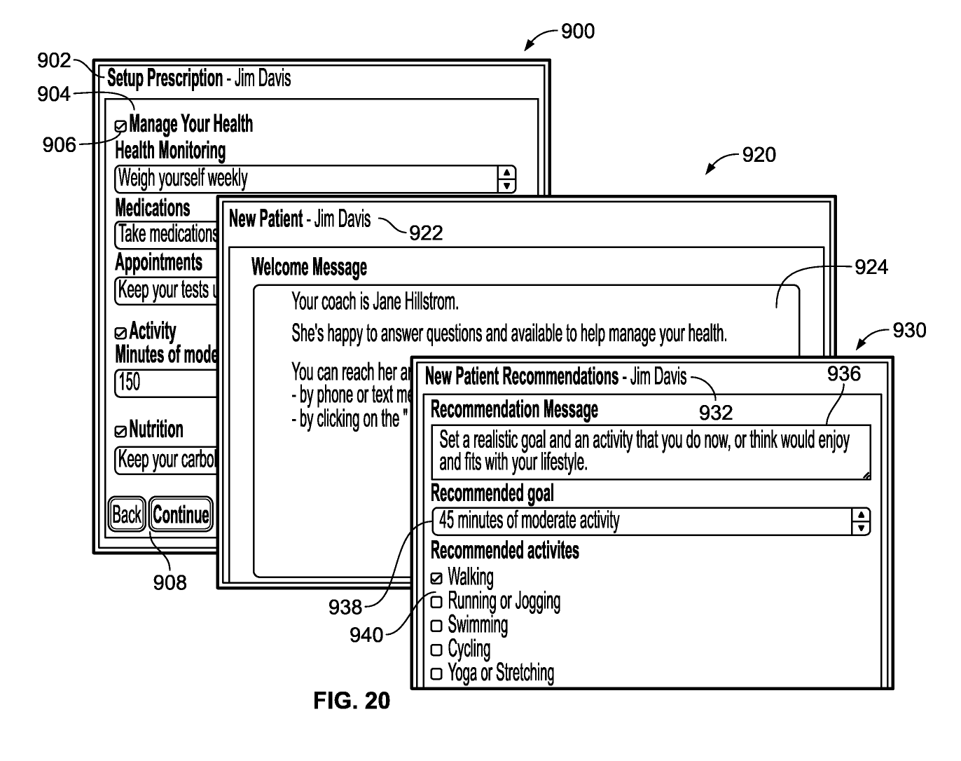

Healthcare staff are provided with additional steps, screens, and tools to assist patients. These tools enable program configuration, individual patient customization, messaging capabilities, status filtering and alerts, messaging, and reporting. They allow the systems and methods described herein to be deployed for large or small populations with varying degrees of customization. Several of these tools are further discussed in FIGS. 20-23.

FIG. 20 depicts coaching interface screens generated by processing circuitry, such as processing circuitry 206 or processing circuitry of an interface device, such as a computer, phone, tablet or other device used by the coach or healthcare provider. Screen 900 is a screen for setting up the patient's overarching health prescription. The prescription, in this sense, does not refer only to prescription medicine, but can refer to other activities, such as diet and exercise. Typically, the prescription is developed by a qualified healthcare provider, such as a physician, dietician, therapist, or other professional. In certain approaches, however, a patient may utilize the systems and methods described herein without a referral or prescription information from a physician or health care provider. The processing circuitry may then provide input options for the patient directly to set goals.

Screen 900 includes a title message 902, such as “Setup Prescription,” which describes screen 900 and may also include patient information, such as the patient's name. Screen 900 includes prescription sections 904. Sections 904 may focus on different aspects of a patient's prescription, including, but not limited to, overall health (weight, medications, appointments with healthcare providers, etc.), activity or exercise, and nutrition. Screen 900 includes user input fields 906 for selecting parts of prescription sections 904 and entering data. For example, fields 906 may include checkboxes, text input boxes, selection boxes, dropdown selections, and/or radio buttons to allow the user to input prescription information. The user, such as a coach, nurse, or other healthcare provider, may input prescription information such as weight, exercise, medication, and nutrition goals. Screen 900 may also include submission buttons 908, such as a “Back” button or “Continue” button similar to those previously described. Upon completion of screen 900, the processing circuitry saves the received data, for example, in storage memory 210 and/or in local memory, such as coach interface device 216 or healthcare provider interface device 218.

Screen 920 is a patient message screen. In the depicted example, screen 920 is specifically for providing a welcome message, which the processing device would deliver to the patient when the patient registers. However, the messaging screen may be used at other times as well to facilitate effective communication between the patient and the coach or other healthcare provider. Screen 920 has a title message 922, which may include the patient's name. Screen 920 additionally has a message box 924, such as a text box, where the user can input the message. In certain approaches, the processing device generates a message, which the coach or healthcare provider can use directly or modify. In certain approaches, the coach or healthcare provider can save a new default message, which can be used by the user in the future. Although not depicted, screen 920 may also include buttons, such as “Save” or “Send.” When activated, the processing device receives the date from screen 920 and is able to provide the message to the patient.

Screen 930 is a recommendation screen. Screen 930 has a title message 932, which may include the patient's name. Screen 930 additionally has a message box 936, such as a text box, where the user can input a message for the patient. In certain approaches, the processing device generates a message, which the coach or healthcare provider can use directly or modify. In certain approaches, the coach or healthcare provider can save a new default message, which can be used by the user in the future. Screen 930 has a recommended goal area 938 and recommended activities area 940. Area 938 and area 940 may both include user input fields, including, but not limited to checkboxes, text input boxes, selection boxes, dropdown selections, and/or radio buttons for providing the recommended goal and activities. Although not depicted, screen 930 may also include buttons, such as “Save” or “Send.” When activated, the processing device receives the date from screen 930 and is able to provide the recommendation message to the patient. In certain approaches, the processing device will provide the recommendation from screen 930 to the patient during the assessment, goal setting, and action plan development process. For example, the recommendation may be included in recommendation area 430 of screen 420.

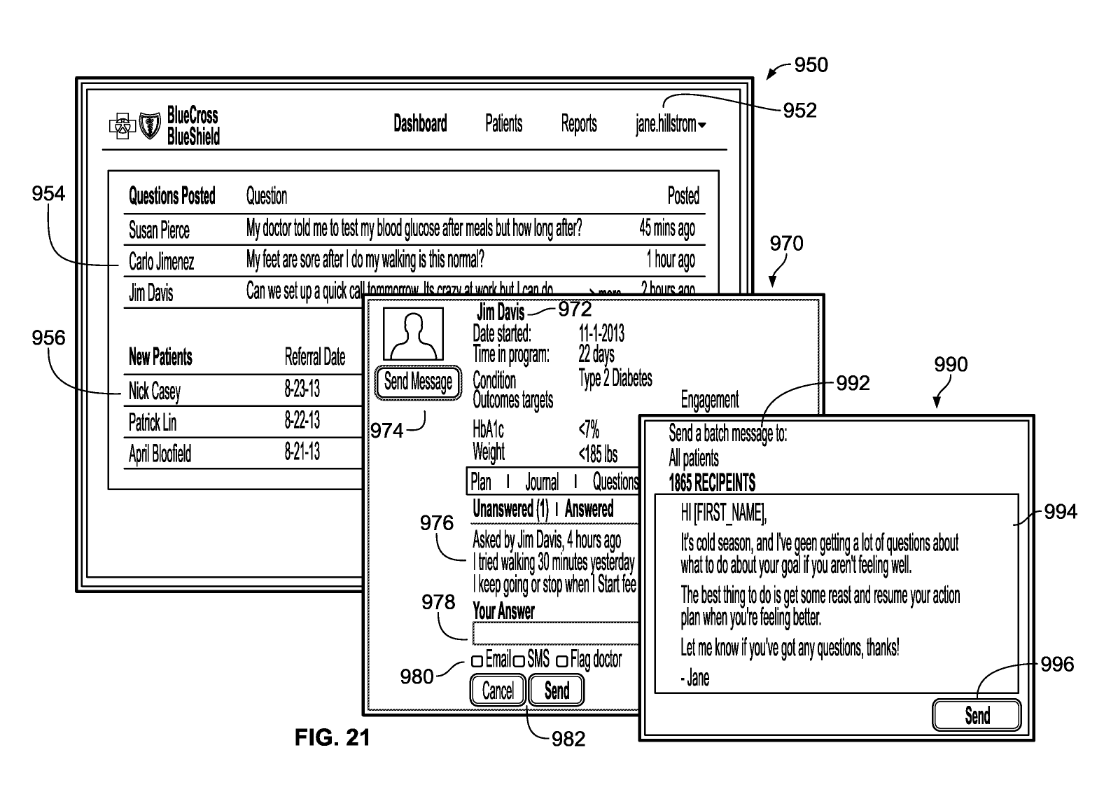

FIG. 21 illustrates screens for coach communication. These screens are generated by the processing device and are designed to create efficiency for the coach or healthcare provider in communicating with patients. For example, the coach or healthcare provider can have one-to-one communication with a patient or one-to-many communication, for example, through batched messaging. Coaches can answer questions and communicate both broadly and individually.

Screen 950 is an example of a nurse or coach communication dashboard. Navigation buttons 952 allow the user to selected specific types of information and screens to view, such as reports and specific patients. In certain approaches, screen 950 includes inbox or question area 954 where the user can see communication, messages, and questions from patients. Area 954 may include patient names, the message or question, and the time posted. In certain approaches, the processing device sorts inbox area 954 to provide more urgent or important messages immediately to the user. The user may click a message to read further or reply to the message. In certain approaches, screen 950 includes new patient area 956. New patient area 956 shows the user which patients have recently been added to the system. Area 956 may include information such as the patient name, referral date, missing information, and next steps. In certain approaches, the user may click in area 956 to obtain more information regarding the new patients or to communicate with the new patients. Although not depicted, other types of information, such as a complete patient list, may also be provided by the processing device through screen 950.

Screen 970 is a patient detail screen. Screen 970 may include a patient identifier 972, such as the patient's name. The patient identifier 972 may also include other information about the patient, including, but not limited to, photo of the patient, date started in the program, time in the program, condition, prescription, goals, and targets. Button 974 is a “Send Message” button. When clicked, the processing device provides a messaging interface for the user to send a message to the patient. In certain approaches, screen 970 includes a patient messaging area 976, where the processing device displays messages from the patient. In certain approaches, screen 970 includes a response box 978, where the user may input messages for the patient. Message options 980 allow the user to select how the message will be sent (e.g., email, SMS, other) and whether other people, such as a physician, should also receive the message. Screen 970 may also include submission buttons 982, such as a “Cancel” button or “Send” button similar to those previously described. Upon completion of screen 970, the processing circuitry saves the received data, for example, in storage memory 210 and/or in local memory, such as coach interface device 216 or healthcare provider interface device 218. If the user has provided a message, the processing device delivers the message to the requested recipient(s) through the appropriate messaging system.

Screen 990 depicts a messaging window, which can be used to send messages many patients in batch form. In certain approaches, screen 990 may also be used to send messages to individual patients. Screen 990 includes a title message 992, which provides overview information about the message, such as which patients are selected to receive the message. Screen 990 additionally includes message input box 994, where the user may input a message to the patients. In certain approaches, the user may use “batch form” syntax, such as [FIRST_NAME], which indicates to the processing device to substitute that syntax for the first name of each patient. Other data can also be processed in batch form, including, but not limited to, patient identification numbers, dates, recommendations, names, physicians, coaches, goals, activities, or other relevant information. In each case, the processing device substitutes the general batch field with the specific data for each patient. Screen 990 may also include submission buttons 996, such as a “Cancel” button or “Send” button similar to those previously described. Upon completion of screen 990, the processing circuitry saves the received data, for example, in storage memory 210 and/or in local memory, such as coach interface device 216 or healthcare provider interface device 218. If the user has provided a message, the processing device delivers the message to the requested recipient(s) through the appropriate messaging system.

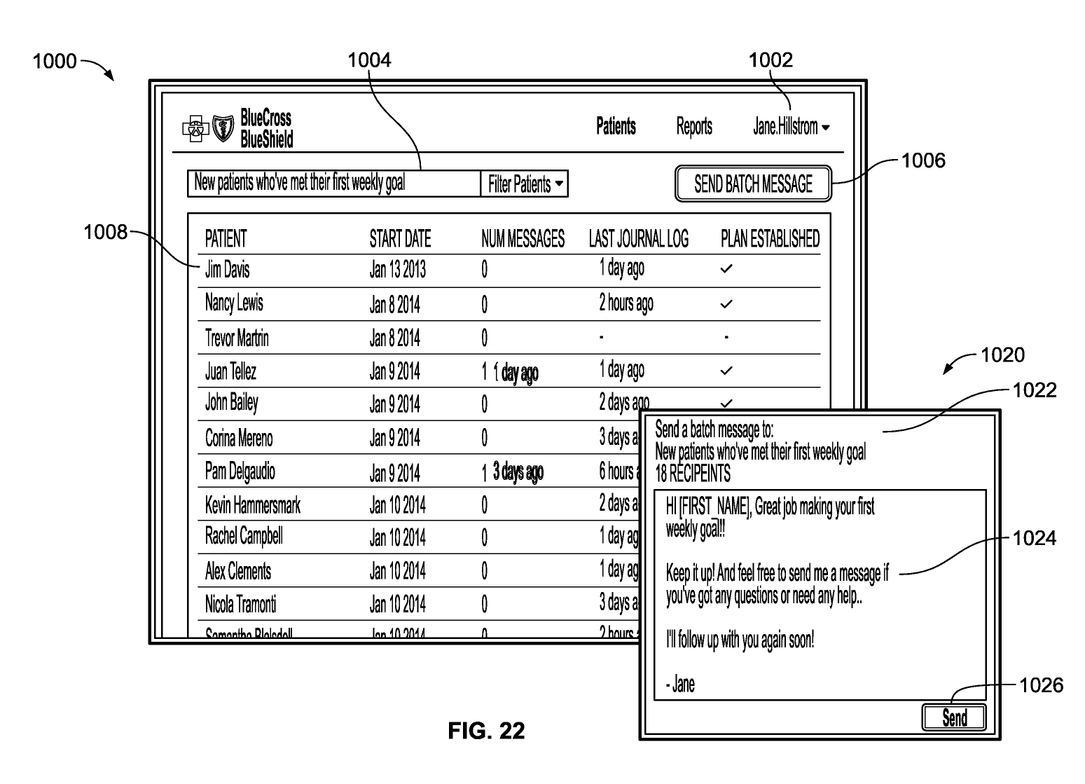

FIG. 22 shows screens for broad scale communication from a coach. The screens are generated by processing circuitry, such as processing circuitry 206 or processing circuitry in a user interface device. Screen 1000 is a patient listing screen, which includes a patient list 1008. List 1008 shows patients for which the coach is responsible. Navigation buttons 1002 allow the user to selected specific types of information and screens to view, such as reports and specific patients.

List 1008 displays patient details, which may include, but are not limited to, patient name, patient identification numbers, dates, recommendations, messages, journal log, physicians, coaches, goals, activities, photos, condition, prescription, whether an action plan has been established, or other relevant information. The patient list may include links, such that when a user clicks on a patient in the list, the processing circuitry displays additional screens or information about the patient, such as screens 800, 970, 1040, 1060, or 1080. In certain approaches, search bar 1004 is included in screen 1000. The search bar may include an input field. In certain approaches, search bar 1004 includes filtering capabilities based on certain patient populations, characteristics, or other data fields. For example, search bar 1004 may be used to search for patients who have met their first weekly goal within the past week. When data is entered into search bar 1004, the processing device can search the patient data and update patient list 1008 to match the searched parameters.

Screen 1000 also includes a button 1006 for sending batched messages. When button 1006 is clicked or activated by the user, the processing circuitry displays a batched message window, such as window 1020, which enables the user to send message to the patients in list 1008. Screen 1020 depicts a messaging window, which can be used to send batched messages many patients. In certain approaches, screen 1020 may also be used to send messages to individual patients. Screen 1020 is similar to previously described batched message screen 990. For example, screen 1020 includes a title message 1022, which provides overview information about the message, such as which patients are selected to receive the message. Screen 1020 additionally includes message input box 1024, where the user may input a message to the patients. In certain approaches, the user may use “batch form” syntax, so that a particular an identified field can be filled in the message by the processing device. Fields may include, but are not limited to, patient identification numbers, dates, recommendations, names, physicians, coaches, goals, activities, or other relevant information. In each case, the processing device substitutes the general batch field with the specific data for each patient. Screen 1020 may also include submission buttons 1026, such as a “Cancel” button or “Send” button similar to those previously described. Upon completion of screen 1020, the processing circuitry saves the received data, for example, in storage memory 210 and/or in local memory, such as coach interface device 216 or healthcare provider interface device 218. If the user has provided a message, the processing device delivers the message to the requested recipient(s) through the appropriate messaging system.

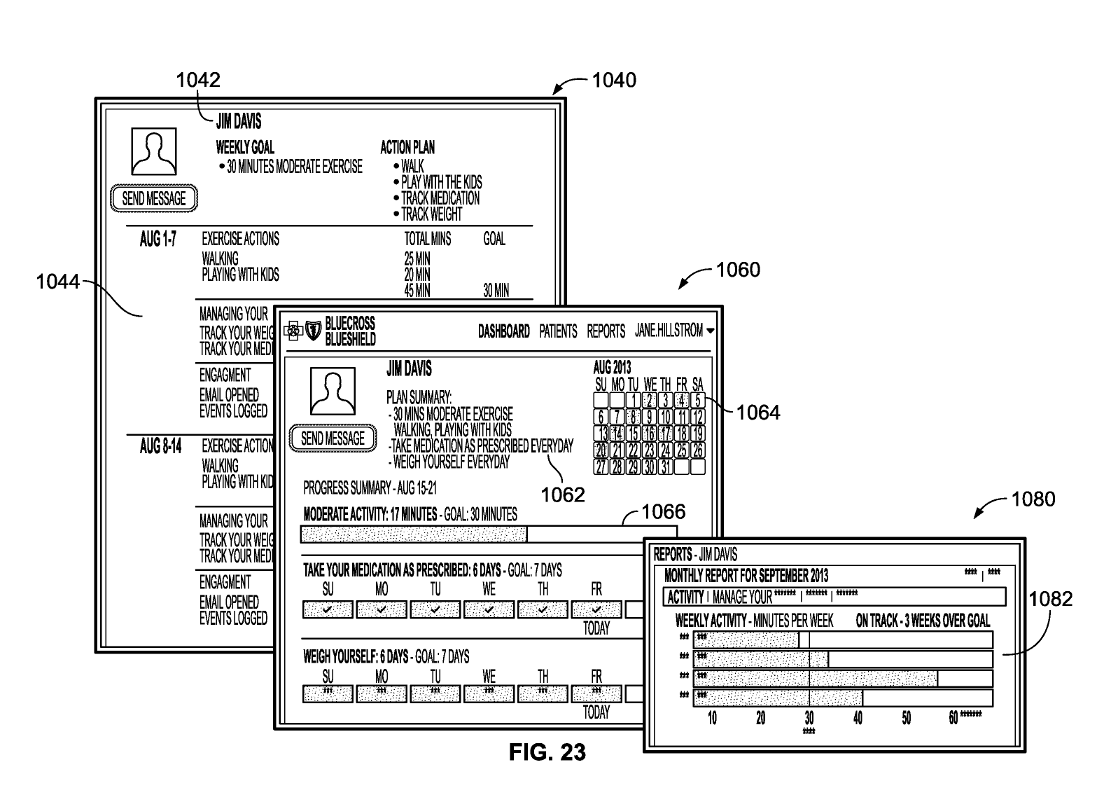

FIG. 23 depicts patient monitoring, measuring, and reporting screens for coaches, which allow coaches or other healthcare providers (e.g., nurses, physicians, therapists) to easily monitor individual patient progress. Screen 1040 is a patient summary screen. Screen 1040 includes a patient identifier 1042, such as the patient's name. The patient identifier 1042 may also include other information about the patient, including, but not limited to, a photo of the patient, date started in the program, time in the program, condition, prescription, goals, targets, and action plan. Identifier 1042 may also include “Send Message” button. When the button is clicked, the processing device provides a messaging interface for the user to send a message to the patient.

Screen 1040 additionally includes patient interval summaries 1044. The interval summaries provide information about a patient's performance over a particular time interval, such as a week or a month. The interval summaries 1044 may include information such as activities performed by the patient, goals, frequency of engagement with the coach (e.g., emails opened, number of times the patient logged data), weight, and other relevant metrics.

Screen 1060 is a patient summary screen that may be used in addition to or alternatively to screen 1040. Screen 1060 includes a patient identifier 1062, such as the patient's name. The patient identifier 1062 may also include other information about the patient, including, but not limited to, a photo of the patient, date started in the program, time in the program, condition, prescription, goals, targets, and action plan. Identifier 1062 may also include “Send Message” button. When the button is clicked, the processing device provides a messaging interface for the user to send a message to the patient.

Screen 1060 includes patient interval summaries 1066. The interval summaries provide information about a patient's performance over a particular time interval, such as a week or a month. The interval summaries 1066 may include information such as activities performed by the patient, goals, frequency of engagement with the coach (e.g., emails opened, number of times the patient logged data), weight, and other relevant metrics. In particular, interval summaries 1066 are displayed to more easily track patient performance compared to patient goals. In certain approaches, summaries 1066 include graphs or other visual displays. Screen 1060 includes a calendar 1060, which provides information such as days being viewed and days when the patient has logged data.

Screen 1080 is a patient report screen. Similar to screens 1040 and 1060, screen 1080 may include a patient identifier and activity summaries, such as summaries 1082. Summaries 1082 show a report of the patient's activity over a given interval. For example, summary 1082 depicts the patient's performance over 4 weeks broken down on a weekly basis.

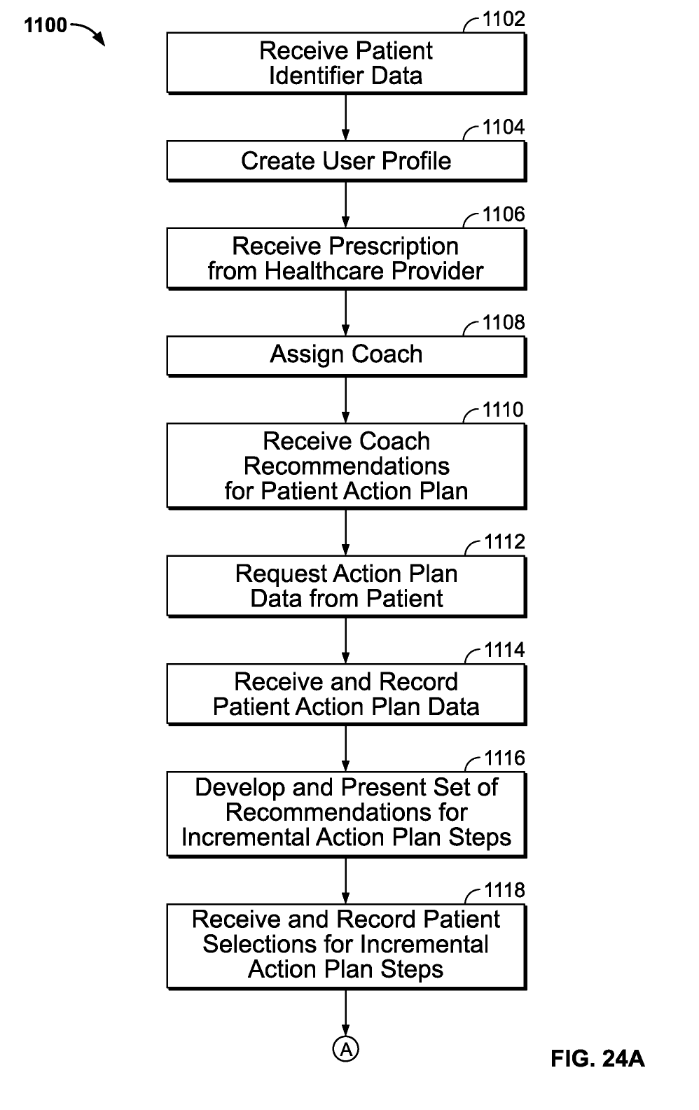

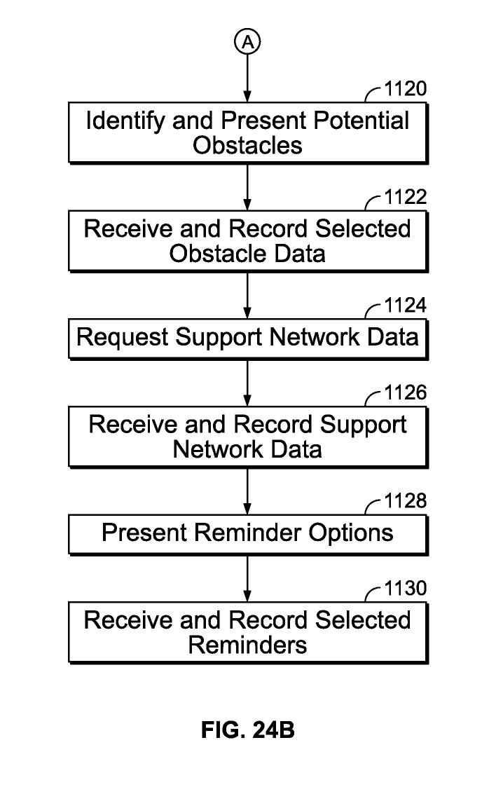

The screens and other tools described herein can be used to interface with patients, coaches, healthcare providers, and the patient's support network. These screens and tools are implemented by the processing circuitry and used in various aspects of the systems, methods, and processes described herein, including the process steps described in further detail in FIGS. 24A-26.

FIG. 24A and FIG. 24B illustrate a process for developing a patient action plan. Process 1100 is performed by processing circuitry, such as processing circuitry 206. In certain approaches, particular steps of process 1100 may be performed by or with assistance from additional processing circuitry, such as processing circuitry in patient interface devices 212, coach interface devices 216, healthcare provider interface devices 218, and supporter interface devices 220.

At step 1102, the processing circuitry receives patient identifier data. Patient identifier information may include, but is not limited to, name, email address, password, patient identification number, healthcare provider, health condition, health records, and/or other forms of identifying information. In certain approaches, this information is provided through a registration interface, such as screen 300 or screen 900. After receiving the patient identifier data, the processing circuitry creates a user profile for the patient. The user profile includes the patient identifier information, and stores it in a retrievable manner in memory storage, such as memory storage 210. The processing circuitry then receives prescription information from the healthcare provider at step 1106. For example, the prescription information may be received through screen 900. The prescription information is typically developed by a qualified healthcare provider and may include medications, goals, health condition, diet guidelines, exercise guidelines, and specific activities for the patient. The processing circuitry then stores the prescription information in the user profile.

In certain approaches, the processing circuitry assigns a coach to the patient and the corresponding user profile at step 1108. In certain approaches, this assignment is made directly from data provided by the coach or the healthcare provider. For example, the processing circuitry may request a coach to be identified at the step 1101 or step 1106. Additionally or alternatively, the processing circuitry may assign a coach based on the patient's health condition and/or prescription. For example, the prescription may include a recommendation for exercise. The processing device can use that information to find a qualified coach who can help the patient meet the prescription guidelines or other goals.

At step 1110, the processing device receives recommendations from the coach or healthcare provider for the patient's action plan. For example, these data may be obtained through an electronic interface, such as screen 930. The processing circuitry stores the recommendations in memory, such as memory storage 210, and in certain approaches, associates these recommendations with the user profile. The processing circuitry then proceeds to step 1112 by requesting specific information and data from the patient. For example, the processing circuitry may use assessment screens, such as those previously described in FIGS. 4-12, and specifically FIGS. 4-6 (e.g., screens 320, 350, 370, 382, 390, 400, etc.). The processing circuitry receives the data through user input fields at step 1114 and records these data in storage, such as memory storage 210.

In certain approaches, the processing device also presents recommendations for incremental steps for implementing the action plan at step 1116. These recommendations may be received in step 1110 from the coach or may be recommendations developed by processing circuitry based on patient data, prescription data, and other health databases and algorithms in storage. For example, when trying to reach a goal of 150 minutes of exercise a week, the processing circuitry may provide a recommendation of initially exercising for 20 minutes a day, 3 times a week. Screen 420 and screen 430 are examples of implementing incremental steps and recommendations for achieving a larger goal. This type of incremental step can be important in helping the patient reach the larger goal and is an important part of the systems and methods described herein. At step 1118, the processing circuitry receives the incremental steps selected by the patient, incorporates them into the patient's action plan, saves them to storage, such as memory storage 210.

In certain approaches, the processing circuitry assists the patient in identifying and planning for potential obstacles or roadblocks that may interfere with the patient's ability to achieve his or her goals. At step 1120, the processing circuitry presents these potential roadblocks and planning steps to overcome them. For example, the processing circuitry may perform step 11120 through screen 520 and screen 534. The processing circuitry then receives the roadblock data, records it (e.g., in memory storage 210), and includes it in the patient's action plan. At step 1124, the processing circuitry may request personal support contacts, such as one or more friends, family members, caretakers, or other support people. For example, step 1124 can be completed using an interface such as screen 550. Having a support network can increase the patient's ability to reach the goals of the action plan. The processing circuitry can provide reports or other information to these support network members, for example, through email, text message, or other communication means. The processing circuitry receives the support network data at step 1126 and records it, for example, in storage 210.

The processing circuitry may proceed to step 1128, where it presents options for setting up reminders for the patient, for example, through screen 500. The reminders can include specified times, dates, frequencies, actions, media (e.g., sounds), and messages. The processing circuitry receives the reminder options through user input fields, stores them (e.g., in storage 210), and incorporates them into the action plan at step 1130.

The data received throughout the process steps is typically stored in memory (e.g., memory storage 210), and associated with the user profile of the patient. Although the steps of process 1100 are shown in a linear fashion, they may be executed or performed in any order or sequence not limited to the order and sequence shown and described in the figure. In certain approaches, steps may be excluded. In certain approaches, steps may be added or combined. For example, in certain approaches, a patient may utilize the systems and methods described herein without a referral or prescription information from a physician. In such cases, the processing circuitry would exclude process step 1106, but continue through process 1100 to develop an action plan using the patient's input. Additionally or alternatively, the processing circuitry may provide an option for the patient to proceed without a human coach. As described previously and below, the processing circuitry provides recommendations for modifying or updating the patient action plan. These recommendations can be presented directly to the patient and serve as a digital coach without a human coach. In such cases, the processing circuitry may exclude steps 1108 and 1110 of process 1100.

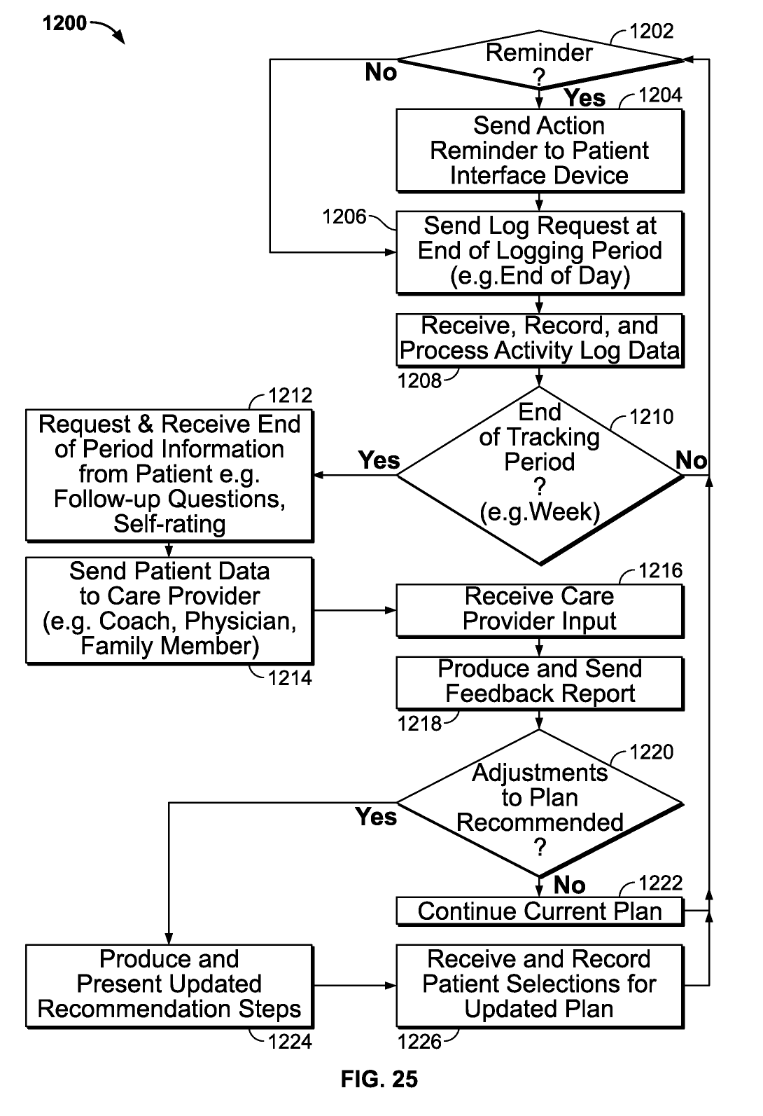

FIG. 25 shows process steps for supporting a patient action plan. Process 1200 is performed by processing circuitry, such as processing circuitry 206. In certain approaches, particular steps of process 1200 may be performed by or with assistance from additional processing circuitry, such as processing circuitry in patient interface devices 212, coach interface devices 216, healthcare provider interface devices 218, and supporter interface devices 220.

At step 1202, the processing circuitry checks whether a reminder was set up for the patient for one or more goals or actions. If so, the processing circuitry proceeds to step 1204 and sends an action reminder to a patient interface device. For example, the processing circuitry may generate screen 612 or screen 620 at patient interface device 212. At the end of the logging period (e.g., end of day), or if not reminder was set up, the processing circuitry performs step 1206 by sending a log request to the patient at a patient interface device. The log request may be similar to reminder screens, such as screens 612 or 620, may be an email, text, or other electronic communication, and may include a link or direct access to the patient's journal (e.g., through screens 600, 630, 650, 660, 670, and 680). The processing circuitry receives the logged data through the submitted user input fields of those respective screens, records the data (e.g., in storage 210), and processes the patient's activity log. For example, the processing circuitry may search for patterns in the patient's data to notify the coach, provide recommendations, and better support the patient's goals.

At step 1210, the processing circuitry checks whether a tracking period, such as a week, has been completed. For purposes of describing the present figure and processes, a tracking period is a longer time period than a logging period and consists of multiple logging periods. For example, a logging period may be a day, while the tracking period may be a week. If the tracking period is not complete, the processing circuitry continues back to step 1202 and checks for a reminder. If the logging period is complete, the processing circuitry requests end of tracking period information from the patient at step 1212. For example, the processing circuitry may display a weekly journal, such as journal page 630. At step 1212, the processing circuitry also receives and saves (e.g., in storage 210) the user data from input fields in the journal page. The processing circuitry then proceeds to step 1214 and sends patient data to care providers. Care providers, in this case, can include coaches, nurses, physicians, and members of the patient's support network. In certain approaches, the control circuitry analyzes the patient data and provides the care providers with messages or recommended action plan changes for the patient. At step 1216, the processing circuitry receives input, such as messages to the patient and recommended changes, from the care provider(s), which the processing circuitry stores (e.g., in memory storage 210). The processing circuitry produces and sends a feedback report to the patient at step 1218. For example, the processing circuitry may generate patient summary screen 830. The processing circuitry may send the feedback report via email, SMS text message, or other communication mean. In certain approaches, the patient can access the report through an electronic summary dashboard, such as a web interface generated by the processing circuitry.

In certain approaches, a patient may utilize the systems and methods described herein without a care provider, such as coaches, nurses, physicians, and members of the patient's support network. In these cases, the processing circuitry may exclude steps involving a care provider (e.g., 1214 and 1216, as well as others described throughout). In certain approaches, the processing circuitry may directly conduct analysis and provide recommendations. In certain cases, the processing circuitry provides a simulated digital care provider.

If no adjustments to the action plan are recommended, then at step 1220, the control circuitry continues to step 1222. The current plan is continued to be implemented by the processing circuitry, which then proceeds back to the reminder process at step 1202. If adjustments are recommended at step 1220, the processing circuitry performs step 1224 and presents updated recommendation steps. In certain approaches, these recommendations steps are those received by care providers at step 1216. Additionally or alternatively, the recommendation steps may be generated by the processing circuitry, for example, by analyzing the patient's activity data and using an algorithm to identify ways to improve the outcome. The patient may be able to input changes to the action plan through user input fields on a screen, such as screen 700 or screen 830. The processing circuitry receives the patient selections at step 1226. The processing device then saves the selections in storage with the patient's profile and updates the patient's action plan. The processing device then continues to implement process 1200 with the updated action plan by proceeding back to the reminder step 1202.

Although the steps of process 1200 are shown in a linear fashion, they may be executed or performed in any order or sequence not limited to the order and sequence shown and described in the figure. In certain approaches, steps may be excluded. In certain approaches, steps may be added or combined. The data received throughout the process steps is typically stored in memory (e.g., memory storage 210), and associated with the user profile of the patient.

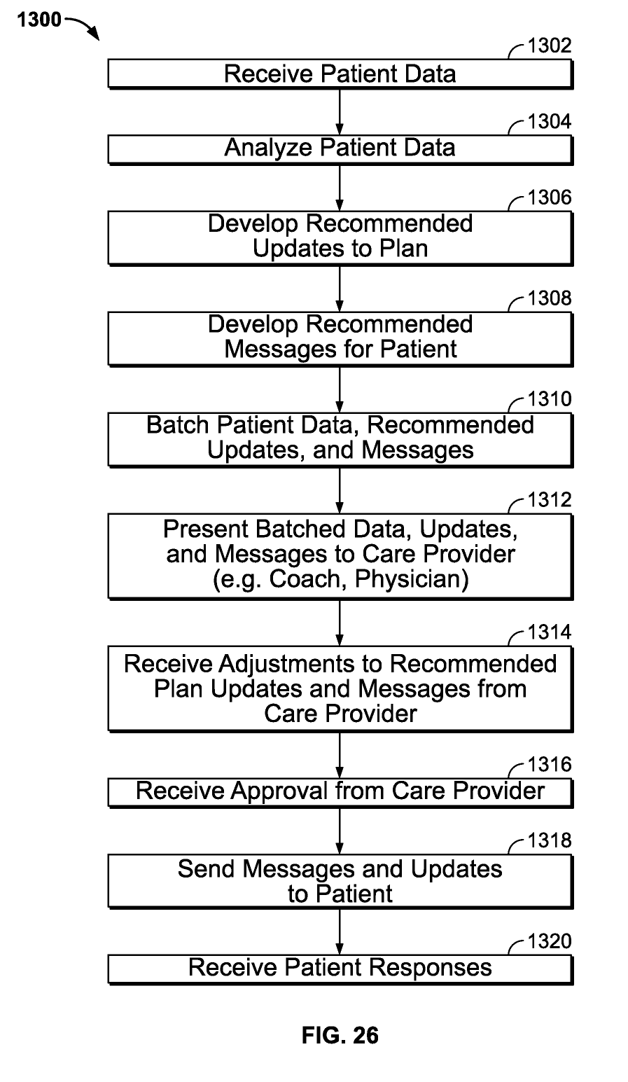

FIG. 26 depicts a process for providing plan updates and patient communication. Process 1300 is performed by processing circuitry, such as processing circuitry 206. In certain approaches, particular steps of process 1000 may be performed by or with assistance from additional processing circuitry, such as processing circuitry in patient interface devices 212, coach interface devices 216, healthcare provider interface devices 218, and supporter interface devices 220.

The processing circuitry receives patient data at step 1302. For example, the processing circuitry may receive patient data through a patient journal or log, such as journal screens 600, 630, 650, 660 670, or 680. After receiving the patient data, the processing circuitry analyzes the patient data at step 1304. Specifically, the processing circuitry looks for patterns or characteristic events in the patient's performance. The processing circuitry can use algorithms, such as searching in lookup tables and databases, or utilizing artificial intelligence algorithms, to develop recommended updates to the patient's action plan at step 1306. The processing circuitry develops recommended messaging for the patient at step 1308. For example, the messaging may include support messages and educational components. The processing circuitry may utilize saved messages from a database, or may develop new, unique messaging based on the analysis of the patient's performance and the resultant recommended updates.

In certain approaches, the processing circuitry batches patient data, recommended updates, and recommended messages at step 1310. For example, the processing circuitry may batch together patients with similar conditions, patients with similar recommended updates, patients with similar messaging, or any combination thereof. In certain approaches, this batching is performed automatically by the processing circuitry. Additionally or alternatively, a user, such as a coach or physician, may request the batching. For example, batching data can be done as previously described in relation to search bar 1004 of screen 1000. This batching process improves the efficiency through which the coaches and healthcare providers can communicate with patients. The processing device then presents the batched data, updates, and messages to care providers, such as a coach, nurse, or physician.

The processing circuitry provides user input fields to allow the care provider to modify the recommended plan updates and messaging. For example, the processing circuitry may provide interface screens such as screen 1000 and screen 1020, which allow a care provider to access and modify recommendations to the patients. These modifications or adjustments are received by the processing circuitry at step 1314. Additionally or alternatively, the care provider approves the plan. This approval is received by the processing circuitry at step 1316. After receiving the care provider approval, the processing circuitry sends the approved messages and update to the patient at step 1318. For example, the processing circuitry may send an email, SMS text message, or provide other electronic communication, such as a web interface. The processing device also provides user input fields, through which the patient can provide responses regarding accepting, declining, or modifying the recommended plan. The processing device receives these responses at step 1320 and saves them in storage to the user profile as an updated action plan, which can be implemented through the systems and methods previously described.

Although the steps of process 1300 are shown in a linear fashion, they may be executed or performed in any order or sequence not limited to the order and sequence shown and described in the figure. In certain approaches, steps may be excluded. In certain approaches, steps may be added or combined. The data received throughout the process steps is typically stored in memory (e.g., memory storage 210), and associated with the user profile of the patient. In certain approaches, a patient may utilize the systems and methods described herein without a care provider, such as coaches, nurses, physicians, and members of the patient's support network. In these cases, the processing circuitry may exclude steps directly involving a care provider. In certain approaches, the processing circuitry may directly conduct analysis and provide recommendations instead of having these process steps performed by a human care provider. In certain cases, the processing circuitry provides a simulated digital care provider.

It should be understood that the above steps of the flow diagrams of FIGS. 24A-26 may be executed or performed in any order or sequence not limited to the order and sequence shown and described in the figures. In certain approaches, steps may be excluded. In certain approaches, steps may be added or combined between processes. For example, the steps of process 1100, 1200, and 1300 may be combined to provide functionality of registration, assessment, goal-setting, monitoring, adjusting, individual communication, and batch communication. Additionally or alternatively, some of the above steps of the flow diagrams of FIGS. 24A-26 may be executed or performed substantially simultaneously where appropriate or in parallel to reduce latency and processing times.

The systems and methods described herein may be modified and configured to meet specific patient needs. For example, the processing circuitry may provide coaching and action plan management without care providers, such as coaches, physicians, and nurses. Additionally, screens and process steps may be modified to add features that incentivize patient behaviors. For example, screens and process steps may include gaming functionality, such as scores, points, and awards. These scores, points, and awards may be related directly to patient performance, or in certain approaches, may include comparisons to other people, such as other users or a database or stored user data. As another example, the processing circuitry may deliver content to a patient or user without the need to directly track an action plan and other user activity. In this way, the systems and methods described herein may act as a configurable content management system that present personalized or non-personalized content to a user in a self-paced manner.

For simplicity, the systems and methods described herein are typically described for the case of including interactions from a human coach. As described previously, a human coach is not required. The processing circuitry is also able to provide recommendations for modifying or updating the patient action plan. These recommendations can be presented directly to the patient and serve as a digital coach without a human coach. The systems and methods may proceed without a human coach, or, in certain embodiments, may simulate a coach. Additionally or alternatively, the systems and methods described herein may be utilized without a physician or healthcare provider. For example, the processing circuitry may allow patients to set goals and action plans without input from a physician. In these cases, a physician or healthcare provider would also not be required during the plan modification steps either (e.g., process 1200). They processing circuitry may provide recommendations, and the patient would be able to fully utilize the system and provided recommendations with or without a healthcare provider and with or without a coach.

The foregoing is merely illustrative of the principles of the disclosure, and the systems, devices, and methods can be practiced by other than the described embodiments, which are presented for purposes of illustration and not of limitation. It is to be understood that the systems, devices, and methods disclosed herein, while shown for use developing new behaviors for adherence to a health regimen, may be applied to systems, devices, and methods to be used in other areas, including, but not limited to, sports coaching, skill acquisition training, professional mentoring, addiction recovery, and other applications involving coaching and acquiring new behaviors or changing current behaviors.

While several embodiments have been described that are exemplary of the present system and methods, one skilled in the art will recognize additional embodiments within the spirit and scope of the systems and methods described herein. Modification and variation can be made to the disclosed embodiments without departing from the scope of the disclosure. Those skilled in the art will appreciate that the applications of the embodiments disclosed herein are varied. Accordingly, additions and modifications can be made without departing from the principles of the disclosure. In this regard, it is intended that such changes would still fall within the scope of the disclosure. Variations and modifications will occur to those of skill in the art after reviewing this disclosure. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented. Therefore, this disclosure is not limited to particular embodiments, but is intended to cover modifications within the spirit and scope of the disclosure.

All references cited herein are incorporated by reference in their entirety and made part of this application.

1. A patient coaching system, comprising:
storage memory; and
processing circuitry configured to:
receive a patient prescription from a healthcare provider and store the patient prescription in the storage memory;
generate action plan steps based on the patient prescription;
receive activity log data at the end of a logging period;
receive healthcare provider input data based on activity log data; and
generate updated action plan steps.

2. The patient coaching system of claim 1, wherein the processing circuitry is configured to receive patient selections for the generated action plan steps.

3. The patient coaching system of claim 2, wherein the processing circuitry is configured to receive obstacle selections from the patient.

4. The patient coaching system of claim 3, wherein the processing circuitry is configured to generate action plan steps based on the received obstacle selections.

5. The patient coaching system of claim 4, wherein the processing circuitry is configured to generate updated action plan steps based on activity log data and healthcare provider input.

6. The patient coaching system of claim 1, wherein the processing circuitry is configured to receive recommended action plan steps from a coach.

7. The patient coaching system of claim 6, wherein the processing circuitry is configured to receive communication messages from the coach and send the received communication messages to the patient.

8. The patient coaching system of claim 7, wherein the processing circuitry provides content resources to the coach for inclusion with communication messages to the patient.

9. The patient coaching system of claim 8, wherein the processing circuitry is configured to:
receive a set of content resources for the patient;
receive a delivery schedule; and
provide the content resources to the patient according to the delivery schedule.

10. The patient coaching system of claim 1, further comprising a patient monitoring device, wherein the patient monitoring device generates activity log data.

11. A method for providing health coaching to a patient, comprising:
receiving, with processing circuitry, a patient prescription from a healthcare provider;
storing, with the processing circuitry, the patient prescription in a storage memory;
generating, with the processing circuitry, action plan steps based on the patient prescription;
receiving, with the processing circuitry, activity log data at the end of a logging period;
receiving, with the processing circuitry, healthcare provider input data based on activity log data; and
generating, with the processing circuitry, updated action plan steps.

12. The method of claim 11, further comprising receiving, with the processing circuitry, patient selections for the generated action plan steps.

13. The method of claim 12, further comprising receiving, with the processing circuitry, obstacle selections from the patient.

14. The method of claim 13, further comprising generating, with the processing circuitry, action plan steps based on the received obstacle selections.

15. The method of claim 14, further comprising generating, with the processing circuitry, updated action plan steps based on activity log data and healthcare provider input.

16. The method of claim 11, further comprising receiving, with the processing circuitry, recommended action plan steps from a coach.

17. The method of claim 16, further comprising receiving, with the processing circuitry, communication messages from the coach and sending, with the processing circuitry, the received communication messages to the patient.

18. The method of claim 17, further comprising providing, with the processing circuitry, content resources to the coach for inclusion with communication messages to the patient.

19. The method of claim 18, further comprising:
receiving, with the processing circuitry, a set of content resources for the patient;
receiving, with the processing circuitry, a delivery schedule; and
providing, with the processing circuitry, the content resources to the patient according to the delivery schedule.

20. The method of claim 11, further comprising generating activity log data with a patient monitoring device.
